(19) United States
(12) Patent Application Publication
(10) Pub. No.: US 2013/0075457 A1
(43) Pub. Date: Mar. 28, 2013

(54) FOLDERS AND RELATED FOLDER ASSEMBLY AND METHODS

(71) Applicants: Jay K. Sato, Mission Viejo, CA (US); Vincent H. Bowman, Highland Park, IL (US)

(72) Inventors: Jay K. Sato, Mission Viejo, CA (US); Vincent H. Bowman, Highland Park, IL (US)

(21) Appl. No.: 13/327,697

(22) Filed: Dec. 15, 2011

Related U.S. Application Data
(63) Continuation-in-part of application No. 29/402,327, filed on Sep. 22, 2011.

(51) Int. Cl. B42F 15/02; B31B 29/00; B31B 1/26; B31B 27/00; B42F 7/08; B31B 1/25

(52) U.S. Cl. 229/67.2; 206/425; 229/67.3; 229/67.4; 493/374; 493/59; 493/162; 493/183

(57) ABSTRACT

A folder assembly including a plurality of telescopically-arranged folders. According to one embodiment, the folder assembly includes a front folder, three identical middle folders, and a rear folder. Each of the folders includes a front panel, a back panel, and a cover flap, the front panel and the back panel jointly defining a pocket having an open top. The back panel of each of the front folder and the three middle folders is configured to include a plurality of integrally-formed flexible hooks. The front panel of each of the three middle folders and the rear folder is configured to include a plurality of integrally-formed flexible straps. The hooks on the back panel of one folder are slidably coupled to the straps of the front panel of the folder directly behind it.

### CROSS-REFERENCE TO RELATED APPLICATION

This application is a continuation-in-part of U.S. patent application Ser. No. 29/402,327, filed Sep. 22, 2011, entitled “File Folder Assembly and Folders for Use Therein” by Vincent H. Bowman and Jeffrey Herz, which is incorporated herein by reference herein in its entirety.

### FIELD OF THE INVENTION

The present invention relates generally to folders and relates more particularly to folder assemblies of the type including a plurality of telescopically-arranged folders, and related methods.

### BACKGROUND

Storage receptacles of the type known as folders are commonly used to store various types of items, such as, but not limited to, paper documents, recording media (DVDs, CDs, flash drives, floppy discs, etc.), and plastic cards (gift cards, credit cards, identification cards, security cards, etc.). One common type of folder includes one or more sheets of material arranged to define a pocket that is accessible through a top or side opening and in which one or more items may be stored. Oftentimes, it is desirable to organize a plurality of items that one wishes to store by storing some items in one folder and storing other items in another folder. As can readily be appreciated, where a plurality of such folders is arranged so that the individual folders are in registry with one another, such as may be the case where the folders, themselves, are stored within a file cabinet or within a portable storage container, it may be difficult to identify the contents of the various folders, without actually removing the contents from the folders, since the contents of a folder or identifying indicia on the folder may be obscured by a neighboring folder. Moreover, with the individual folders arranged in registry with one another, it may be difficult to gain access to the pocket of a desired folder, for example, to insert an item into the pocket or to remove an item from the pocket, since the openings to the pockets of the various folders are positioned close to one another.

One approach to the above problems has been to provide a folder assembly including a plurality of telescopically-arranged folders. With such an arrangement of folders, by telescopically expanding the assembly, labels or other identifying indicia that previously were obscured by an adjacent folder may be revealed, as may also be the contents of the folders, themselves. In addition, by telescopically expanding the assembly, one may more easily gain access to the pockets of the respective folders. An example of such an assembly is disclosed in U.S. Pat. No. 4,871,066, which issued Oct. 3, 1989, by David LaWall, and which is incorporated herein by reference in its entirety. In the LaWall patent, there is disclosed an assembly of telescoping file folders, the assembly providing a lost motion telescoping connection between containers with pockets for receiving articles by means of a connection flap from a front such container extending into an article-receiving pocket in a next container to the rear, the containers being stackable in registry and the top edge of rearmost container being exposed by lifting it, until the lost motion connection causes the next successive forward container to be lifted as well. The next container lifts yet a next container, and so on. The flap on the ultimate rearmost container can be turned forwardly to neatly close the stack in a single closed package. Accordingly, containers are stacked in registry in a compact and orderly fashion, and the user can easily scan the labeled edges of a plurality of containers by merely pulling a rearmost container out of registry, engaging the connecting flap of the next successive container, and pulling a plurality of such containers out of registry until locating a desired one. The desired one is separated by lifting the next forward container until its flap clears the desired container. The invention can be operated in a vertical-pulling arrangement, and is likewise operable by arranging the flap and pocket for sideways motion.

Another example of an assembly of telescopically-arranged folders is disclosed in U.S. Pat. No. 6,758,336 B2, which issued Jul. 6, 2004, by Norio Kohana, and which is incorporated herein by reference in its entirety. In the Kohana patent, there is disclosed a storage case including a plurality of unit cases each consisting of a front panel and a rear panel, defining between them a pocket in which content is received, wherein the plurality of unit cases is coupled to each other with a coupling means formed in the rear panel of a forward one of adjacent unit cases and a one formed in the front panel of a rearward one so that the unit cases will be superposed on each other in the back-and-forth direction and the rearward one of the unit cases will be movable in a predetermined direction in relation to the forward one. The coupling means includes right and left engagement pieces formed, by cutting, each like a tongue-shaped piece in the front panel of the rearward unit case with a predetermined distance between them, and corresponding right and left engagement holes formed in the rear panel of the forward unit case with a predetermined distance between them. Each of the unit cases has a folding panel formed contiguously to, and along a return line at, the upper end of the rear panel. The folding panel of the forward unit case is disposed in the pocket of the rearward unit case, and the front panel of the rearward unit case is disposed between the rear panel and folding panel of the forward unit panel.

Although telescopic folder assemblies of the types described above do ameliorate many of the problems discussed above, these assemblies can encounter difficulties in smoothly telescoping open and shut. In addition, the initial assembly of these products can be difficult as the mechanisms on adjacent folders that are responsible for endowing the product with the capacity for telescopic movement must be coupled to one another in a specific manner.

Thus, there is a need for a folder assembly of the type including a plurality of telescopically-arranged folders wherein the folders are capable of smoothly telescoping open and shut and wherein the telescopic mechanism coupling adjacent folders may be easily assembled.

### SUMMARY

According to one aspect of the invention, there is provided a folder assembly that includes a first folder, the first folder including a first hook; and a second folder, the second folder including a first strap, and wherein the first hook of the first folder is slidably coupled to the first strap of the second folder, whereby the first folder and the second folder are telescopically coupled to one another.

According to one feature of the aforementioned folder assembly, the first folder can further include a second hook and the second hook of the first folder can be slidably coupled to the first strap of the second folder.

According to another feature of the aforementioned folder assembly, the second folder can further include a second strap, the first folder can further include a second hook, and the second hook of the first folder can be slidably coupled to the second strap of the second folder.

According to another feature of the aforementioned folder assembly, the first folder can include a front panel, a back panel, and a pocket, the pocket can be at least in part defined by the front panel and the back panel, and the first hook can be integrally formed in the back panel.

According to another feature of the aforementioned folder assembly, the second folder can include a front panel, a back panel, and a pocket, the pocket can be at least in part defined by the front panel and the back panel, and the first strap can be integrally formed in the front panel.

According to another feature of the aforementioned folder assembly, the first folder can include a front panel, a back panel, and a pocket, the pocket of the first folder can be at least in part defined by the front panel and the back panel of the first folder, and the first hook can be integrally formed in the back panel of the first folder, and the second folder can include a front panel, a back panel, and a pocket, the pocket of the second folder can be at least in part defined by the front panel and the back panel of the second folder, and the first strap can be integrally formed in the front panel of the second folder.

According to another feature of the aforementioned folder assembly, the first folder can further include a cover flap, the cover flap of the first folder inserted into the pocket of the second folder.

According to another feature of the aforementioned folder assembly, the first folder can be generally rectangular and can include an open top, a bottom, and a pair of sides, the second folder can be generally rectangular and can include an open top, a bottom, and a pair of sides, the first strap can be oriented generally parallel to the sides of the second folder, and the first hook can be oriented at a downward angle relative to an imaginary line perpendicular to the sides of the first folder.

According to another feature of the aforementioned folder assembly, the first hook can be defined by a through-cut in the first folder, the through-cut having a first terminal end and a second terminal end and defining a long leg, a short leg, and a transverse leg, the long leg fixed to the first folder, the short leg not fixed to the first folder, the transverse leg interconnecting the long leg and the short leg.

According to another feature of the aforementioned folder assembly, the first terminal end and the second terminal end of the through-cut can be spaced different distances from the sides of the first folder.

According to another feature of the aforementioned folder assembly, at least one of the first folder and the second folder further can include a closure mechanism for maintaining the first and second folders in registry with one another.

According to another feature of the aforementioned folder assembly, the closure mechanism can include a knob on one of the first and second folders and an elastic loop on the other of the first and second folders.

According to another feature of the aforementioned folder assembly, the second folder can further include a first hook, the folder assembly can further include a third folder, the third folder can include a first strap, and the first hook of the second folder can be slidably coupled to the first strap of the third folder, whereby the second folder and the third folder are telescopically coupled to one another.

According to another feature of the aforementioned folder assembly, the third folder can further include a first hook, the folder assembly can further include a fourth folder, the fourth folder can include a first strap, and the first hook of the third folder can be slidably coupled to the first strap of the fourth folder, whereby the third folder and the fourth folder are telescopically coupled to one another.

According to another feature of the aforementioned folder assembly, the fourth folder can further include a first hook, the folder assembly can further include a fifth folder, the fifth folder can include a first strap, and the first hook of the fourth folder can be slidably coupled to the first strap of the fifth folder, whereby the fourth folder and the fifth folder are telescopically coupled to one another.

According to another feature of the aforementioned folder assembly, the second, third, and fourth folders can be identical.

According to another aspect of the invention, there is provided a folder assembly, the folder assembly including a first folder, the first folder including a front panel and a back panel, the front panel and the back panel interconnected at their respective bottoms by a fold line and joined to each other at their respective sides, whereby the front panel and the back panel jointly define a pocket having an open top, the back panel configured to define a plurality of flexible hooks; and a second folder, the second folder including a front panel and a back panel, the front panel and the back panel interconnected at their respective bottoms by a fold line and joined to each other at their respective sides, whereby the front panel and the back panel jointly define a pocket having an open top, the front panel configured to define a plurality of flexible straps, wherein the flexible hooks of the first folder are slidably coupled to the flexible straps of the second folder, whereby the first folder and the second folder are telescopically coupled to one another.

According to a feature of the aforementioned folder assembly, the flexible hooks on the back panel of the first folder can be arranged in two groups, with one of the two groups of flexible hooks is slidably coupled to a first flexible strap and with the other of the two groups of flexible hooks is slidably coupled to a second flexible strap.

According to another feature of the aforementioned folder assembly, the first and second flexible straps can be parallel to one another and can be parallel to the sides of the second folder.

According to another feature of the aforementioned folder assembly, the first and second flexible straps can be defined by through-cuts in the front panel of the second folder.

According to another feature of the aforementioned folder assembly, the first flexible strap can be defined by a first pair of through-cuts in the front panel of the second folder and the second flexible strap can be defined by a second pair of through-cuts in the front panel of the second folder.

According to another feature of the aforementioned folder assembly, the flexible hooks can be angled downwardly relative to an imaginary line perpendicular to the sides of the back panel of the first folder.

According to another feature of the aforementioned folder assembly, each of the flexible hooks can be defined by a single through-cut in the back panel of the first folder.

According to another feature of the aforementioned folder assembly, each of the two groups of flexible hooks can include at least two flexible hooks.

According to another feature of the aforementioned folder assembly, each of the at least two flexible hooks can include a long leg, a short leg, and a transverse leg, the long leg fixed to the first folder proximate to a first side, the short leg not fixed to the first folder, the transverse leg interconnecting the long leg and the short leg.

According to another feature of the aforementioned folder assembly, each of the at least two flexible hooks can include a bottom hook, each of the through-cuts can include an upper terminal end and a lower terminal end, the lower terminal end of the through-cut for the bottom hook can be closer to the first side than is the upper terminal end of the through-cut for the bottom hook and than are the upper and lower terminal ends of the remaining hooks of the at least two flexible hooks.

According to another feature of the aforementioned folder assembly, the first folder can further include a cover flap, the cover flap can be connected to the back panel by a fold line, and the cover flap can be inserted into the pocket of the second folder.

According to another feature of the aforementioned folder assembly, at least one of the first folder and the second folder can further include a closure mechanism for maintaining the first and second folders in registry with one another.

According to another feature of the aforementioned folder assembly, the second folder can further include a cover flap, the cover flap can be connected to the back panel by a fold line, and the closure mechanism can include a knob on the front panel of the first folder and an elastic loop on the cover flap of the second folder.

According to another feature of the aforementioned folder assembly, the back panel of the second folder can be configured to define a plurality of flexible hooks, the folder assembly can further include a third folder, the third folder can include a front panel and a back panel, the front panel and the back panel can be interconnected at their respective bottoms by a fold line and can be joined to each other at their respective sides, whereby the front panel and the back panel jointly define a pocket having an open top, the front panel can be configured to define a plurality of flexible straps, and the flexible hooks of the second folder can be slidably coupled to the flexible straps of the third folder, whereby the second folder and the third folder are telescopically coupled to one another.

According to another aspect of the invention, there is provided a method of assembling a plurality of folders, the method including the steps of (a) providing a first folder, the first folder including a first hook; (b) providing a second folder, the second folder including a first strap; and (c) slidably coupling the first hook of the first folder on the first strap of the second folder so as to telescopically couple the first folder and the second folder to one another.

According to a feature of the aforementioned method, the slidably coupling step can include hooking the first hook around a side edge of the first strap.

According to another feature of the aforementioned method, the first folder can have a cover flap and the said second folder can have a pocket, and the method can further include the step of inserting the cover flap of the first folder into the pocket of the second folder.

According to another feature of the aforementioned method, the second folder can further include a first hook, and the method can further include the steps of providing a third folder, the third folder including a first strap, and slidably coupling the first hook of the second folder on the first strap of the third folder so as to telescopically couple the second folder and the third folder to one another.

According to another feature of the aforementioned method, the first hook can be formed by a through-cut in a back panel of the first folder.

According to another feature of the aforementioned method, the first strap can be formed by a through-cut in a front panel of the second folder.

According to another feature of the aforementioned method the first strap can be formed by a through-cut in a front panel of the second folder.

According to another feature of the aforementioned method, the first folder can be generally rectangular and can include an open top, a bottom, and a pair of sides, the second folder can be generally rectangular and can include an open top, a bottom, and a pair of sides, the first strap can be oriented generally parallel to the sides of the second folder, and the first hook can be oriented at a downward angle relative to an imaginary line perpendicular to the sides of the first folder.

According to another feature of the aforementioned method, the first folder providing step can include the steps of (i) providing a sheet of material, (ii) cutting and scoring the sheet of material to form a first folder blank including a first panel, a second panel joined to the first panel by a first fold line, and a third panel joined to the second panel by a second fold line, the first panel including a pair of side flaps, the second panel including a through-cut defining the first hook, (iii) folding the first folder blank about the first fold line to bring together a rear surface of the first panel and a front surface of the second panel, (iv) joining the side flaps to a rear surface of the second panel, whereby the first panel and the second panel jointly define a pocket having an open top, and (v) folding the first folder blank about the second fold line to form a cover flap.

According to another feature of the aforementioned method, the joining the side flaps to the rear surface of the second panel of the first folder blank includes welding the side flaps to the rear surface of the second panel of the first folder blank.

According to another feature of the aforementioned method, the joining the side flaps to the rear surface of the second panel of the first folder blank includes gluing the side flaps to the rear surface of the second panel of the first folder blank.

According to another feature of the aforementioned method, the second folder providing step can include the steps of (i) providing a sheet of material, (ii) cutting and scoring the sheet of material to form a second folder blank including a first panel, a second panel joined to the first panel by a first fold line, and a third panel joined to the second panel by at least one second fold line, the first panel including a pair of side flaps and a through-cut defining the first strap, (iii) folding the second folder blank about the first fold line to bring together a rear surface of the first panel and a front surface of the second panel, (iv) joining the side flaps to a rear surface of the second panel, whereby the first panel and the second panel jointly define a pocket having an open top, and (v) folding the blank about the at least one second fold line to form a cover flap.

According to another feature of the aforementioned method, the joining the side flaps to the rear surface of the second panel of the second folder blank includes welding the side flaps to the rear surface of the second panel of the second folder blank.

According to another feature of the aforementioned method, the joining the side flaps to the rear surface of the second panel of the second folder blank includes gluing the side flaps to the rear surface of the second panel of the second folder blank.

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention. Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other advantages of this invention, will be more completely understood and appreciated by referring to the following more detailed description of the presently preferred exemplary embodiments of the invention in conjunction with the accompanying drawing figures, which are hereby incorporated into and constitute a part of this specification. It should be noted that the drawings are not drawn to scale. In the drawings wherein like reference numerals represent like parts:

FIG. 1 is a front view of one embodiment of a folder assembly constructed according to the present invention, the folder assembly being shown in a compacted state, with the cover flap of the rear folder closed against the front panel of the front folder;

FIGS. 2(a), 2(b), 2(c), 2(d), 2(e), 2(f), and 2(g) are front perspective, front elevational, right-side elevational, left-side elevational, rear elevational, top plan, and bottom plan views, respectively, of the folder assembly of FIG. 1, the folder assembly being shown in a compacted state, with the cover flap of the rear folder being partially opened;

FIGS. 3(a), 3(b), 3(c), 3(d), 3(e), 3(f), and 3(g) are front perspective, front elevational, right-side elevational, left-side elevational, rear elevational, top plan, and bottom plan views, respectively, of the folder assembly of FIG. 1, the folder assembly being shown in an expanded state, with the cover flap of the rear folder being partially opened;

FIG. 4 is a fragmentary front elevational view of the folder assembly of FIG. 1 in a compacted state with the cover flap of the rear folder being shown partially opened and with the front folder, except for the hooks on the back panel thereof, not being shown to illustrate the telescopic connection of the front folder to its adjacent middle folder;

FIG. 5 is a fragmentary front elevational view of the folder assembly of FIG. 1 in an expanded state, with the front folder, except for the hooks on the back panel thereof, not being shown to illustrate the telescopic connection of the front folder to its adjacent middle folder;

FIGS. 6(a), 6(b), 6(c), 6(d), 6(e), 6(f), and 6(g) are front perspective, front elevational, right-side elevational, left-side elevational, rear elevational, bottom plan, and top plan views, respectively, of the front folder shown in FIG. 1, the front folder being shown with its cover flap folded rearwardly against the back surface of the front folder back panel;

FIG. 7 is a flowchart, schematically illustrating one method of manufacturing the front folder shown in FIGS. 6(a) through 6(g);

FIGS. 8(a) and 8(b) are top plan and side elevational views, respectively, of a blank cut and scored according to the method of FIG. 7;

FIGS. 9(a), 9(b), 9(c), 9(d), 9(e), 9(f), and 9(g) are front perspective, front elevational, right-side elevational, left-side elevational, rear elevational, bottom plan, and top plan views, respectively, of one of the three identical middle folders shown in FIG. 1, the middle folder being shown with its cover flap folded rearwardly against the back surface of the middle folder back panel;

FIG. 10 is a flowchart, schematically illustrating one method of manufacturing the middle folder shown in FIGS. 9(a) through 9(g);

FIGS. 11(a) and 11(b) are top plan and side elevational views, respectively, of a blank cut and scored according to the method of FIG. 10;

FIGS. 12(a), 12(b), 12(c), 12(d), 12(e), 12(f), and 12(g) are front perspective, front elevational, right-side elevational, left-side elevational, rear elevational, top plan, and bottom plan views, respectively, of the rear folder shown in FIG. 1, the rear folder being shown with its cover flap folded partially forwardly; and

FIG. 13 is a flowchart, schematically illustrating one method of manufacturing the rear folder shown in FIGS. 12(a) through 12(g);

FIGS. 14(a) and 14(b) are top plan and side elevational views, respectively, of a blank cut and scored according to the method of FIG. 13; and

FIG. 15 is a flowchart, schematically illustrating one method of assembling the folder assembly of FIG. 1.

### DETAILED DESCRIPTION

The present invention is embodied in folder assemblies, and related methods. Folder assemblies come in a multitude of configurations. It will be appreciated that modifications to disclosed and described examples, arrangements, configurations, components, elements, apparatuses, methods, materials, etc., can be made and may be desired for a specific application. In this disclosure, any identification of specific shapes, materials, techniques, arrangements, thicknesses, etc., are either related to a specific example presented or are merely a general description of such a shape, material, technique, arrangement, thickness, etc. Identification of specific details or examples are not intended to be, and should not be, construed as mandatory or limiting unless specifically designated as such. A few non-limiting examples of folder assemblies are discussed below.

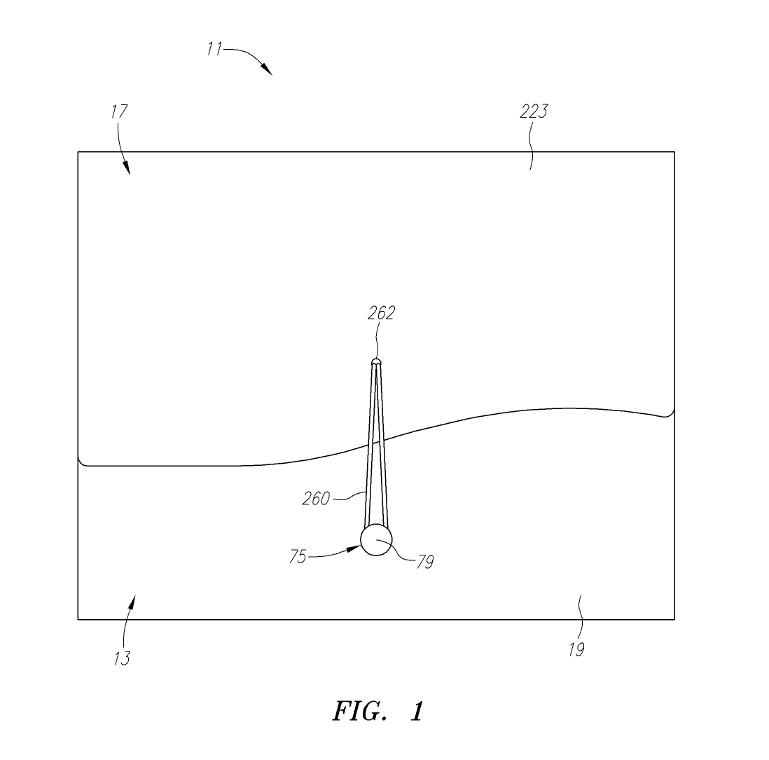

Referring now to FIGS. 1, 2(a) through 2(g), 3(a) through 3(g), 4, and 5, there are shown various views of one embodiment of a folder assembly constructed according to the present invention, the folder assembly being represented generally by reference numeral 11 (it being understood that, for clarity, certain components of folder assembly 11 may not be shown in all of FIGS. 1 through 5).

For purposes of the present specification and claims, unless otherwise specified, the term “plurality” is defined to mean “two or more.”

Folder assembly 11 can include a front folder 13, three identical middle folders 15-1 through 15-3, respectively, and a rear folder 17, with each of folders 13, 15-1 through 15-3, and 17 being telescopically coupled to the folder(s) directly adjacent thereto in the manner described below. It should be understood that, although the present embodiment is shown including three middle folders 15-1 through 15-3, the invention is not limited to an assembly including three middle folders and could include more than three middle folders or less than three middle folders. In fact, the present invention can include no middle folders at all and can consist merely of front folder 13 and rear folder 17.

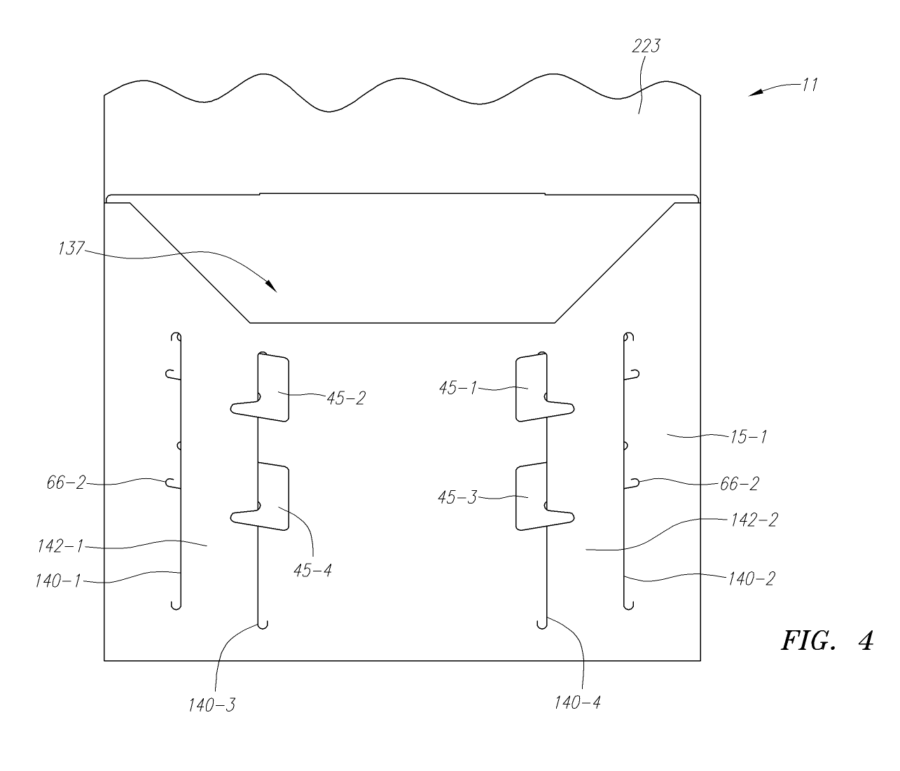

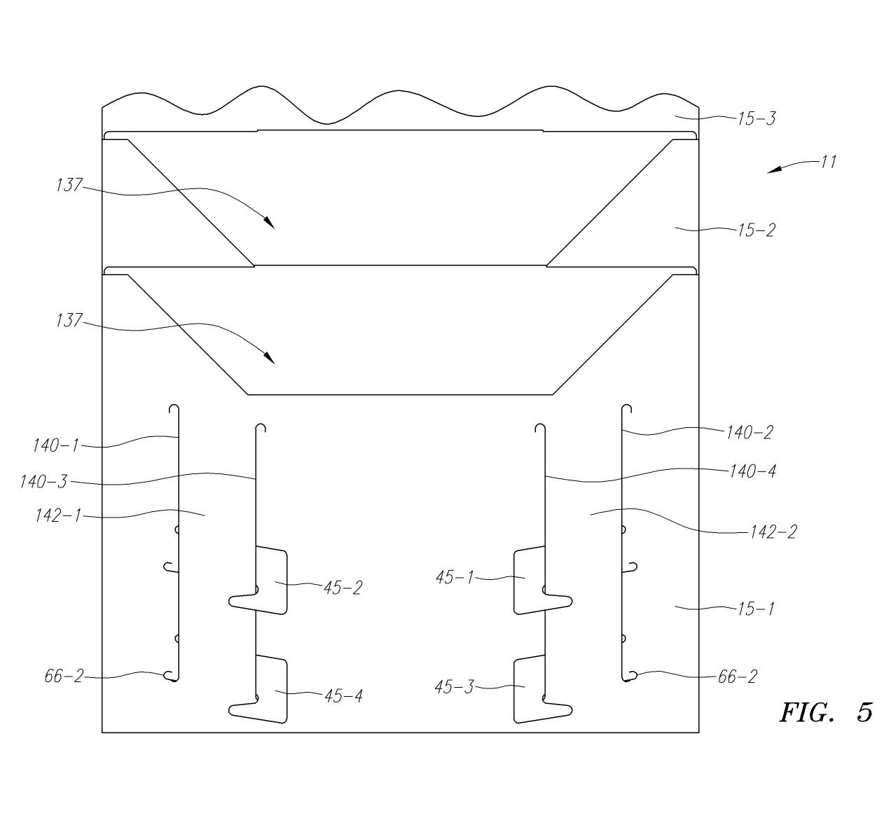

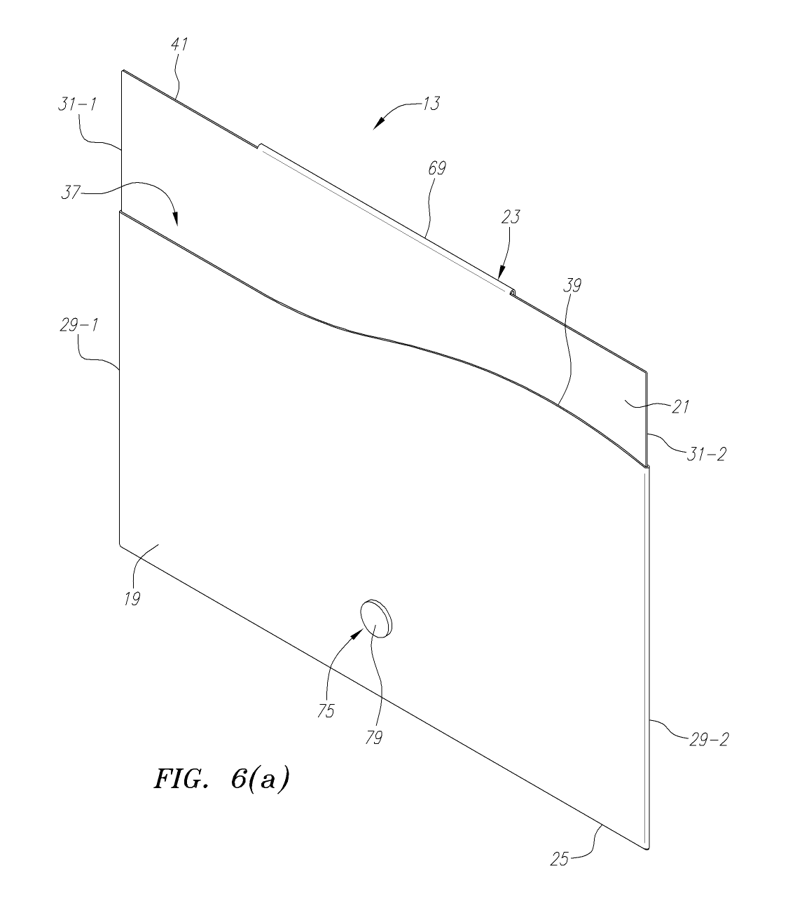

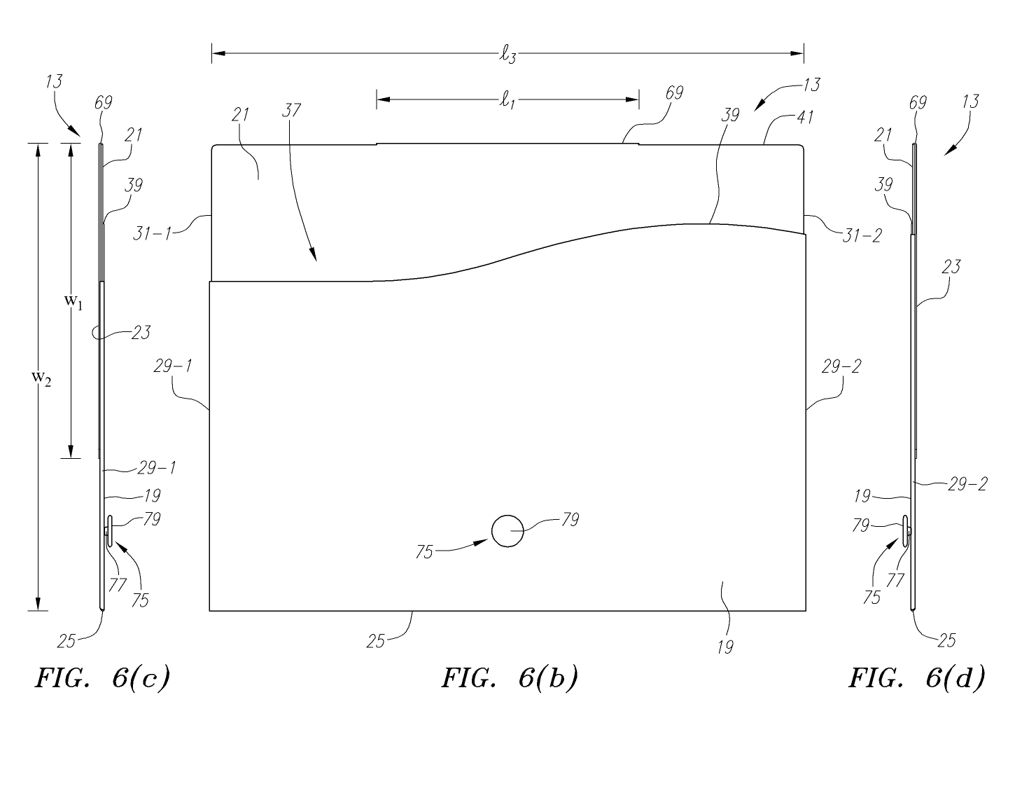

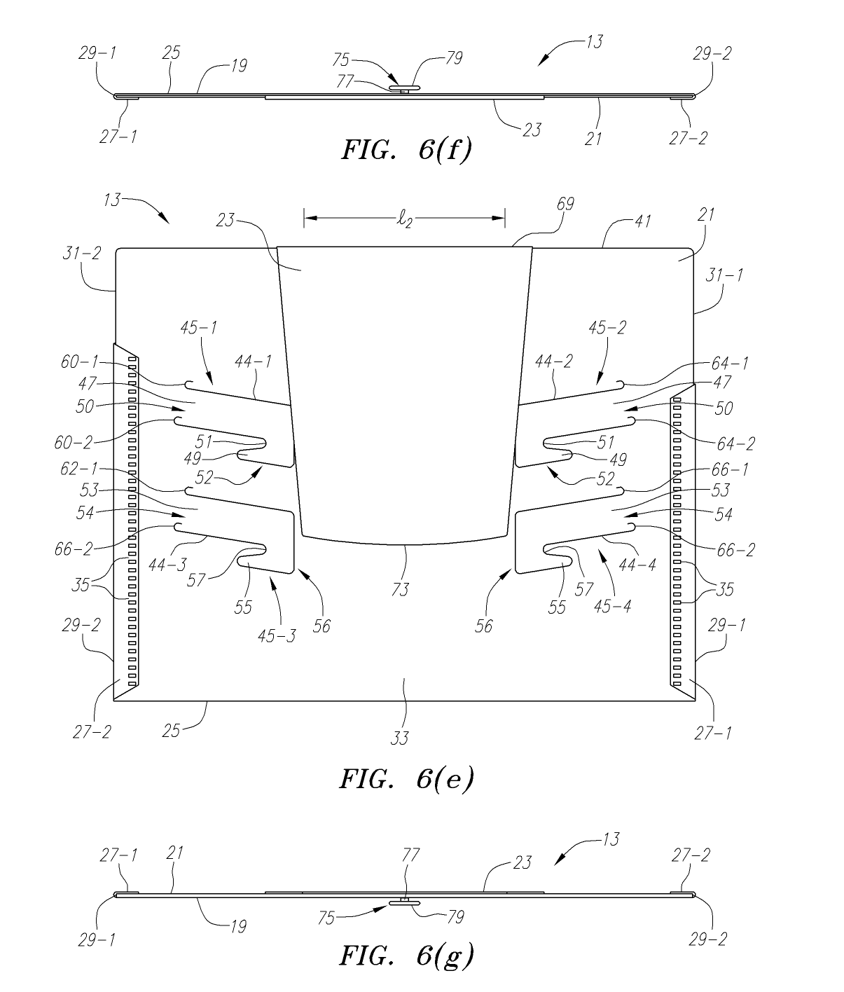

Referring now to FIGS. 6(a) through 6(g), there are shown various views of front folder 13. Front folder 13 includes a front panel 19, a back panel 21, and a cover flap 23. Front panel 19 and back panel 21 are interconnected at their respective bottom edges by a fold line 25. In addition, a pair of side flaps 27-1 and 27-2, which are integrally formed with the right and left side edges 29-1 and 29-2, respectively, of front panel 19, are folded around the right and left side edges 31-1 and 31-2, respectively, of back panel 21 and are joined to the back surface 33 of back panel 21 by a plurality of welds 35. Alternatively, it should be understood that the side flaps 27-1 and 27-2 can be joined to the back surface 33 of the back panel 21, for example, by gluing, stapling, stitching, or other mechanical techniques, In this manner, front panel 19 and back panel 21 jointly define a pocket 37 having an open top.

Front panel 19 has a top edge 39 that is spaced downwardly relative to a top edge 41 of back panel 21 to enable the viewing of a portion of a document or other appropriately sized item disposed within pocket 37, thereby facilitating a user in the identification of the contents of pocket 37 without requiring the user to remove the contents from pocket 37. In addition, because top edge 39 is spaced downwardly relative to top edge 41, one can position an appropriately dimensioned label or other indicia on the front surface of back panel 21 without having the same obscured from view by front panel 19. It should be understood that, although a portion of top edge 39 is shown in the present embodiment as having a curved wave-like shape, top edge 39 need not be so shaped.

Back panel 21 includes a plurality of through-cuts 44-1 through 44-4 defining a corresponding plurality of J-shaped hooks 45-1 through 45-4, respectively. As will be discussed further below, J-shaped hooks 45-1 through 45-4 are part of a mechanism for coupling front folder 13 to middle folder 15-1 to enable telescopic movement therebetween. J-shaped hooks 45-1 through 45-4 are symmetrically arranged on back panel 21 in two columns of two, with J-shaped hooks 45-1 and 45-2 being mirror images of one another and with J-shaped hooks 45-3 and 45-4 being mirror images of one another. (It is to be understood that the number and arrangement of J-shaped hooks 45-1 through 45-4 in the present embodiment is merely illustrative and that there may be a greater number or lesser number of J-shaped hooks 45-1 through 45-4 and/or that these J-shaped hooks may be arranged in a different fashion.) J-shaped hooks 45-1 through 45-4 are preferably angled downwardly slightly (e.g., 10 degrees) towards fold line 25 to reduce the likelihood that paper or other items inserted into pocket 37 may become caught in cuts 44-1 through 44-4. Each of J-shaped hooks 45-1 and 45-2 (also referred to as upper hooks) includes a long leg 47 fixed at one end to back panel 21, a short leg 49 generally parallel to long leg 47, and a transverse leg 51 interconnecting long leg 47 and short leg 49. J-shaped hooks 45-1 and 45-2 are arranged so that their fixed ends 50 are proximate to side edges 31-2 and 31-1, respectively, and so that their free ends 52 are distal to side edges 31-2 and 31-1, respectively. Similarly, each of J-shaped hooks 45-3 and 45-4 (also referred to as bottom hooks) includes a long leg 53 fixed at one end to back panel 21, a short leg 55 generally parallel to long leg 47, and a transverse leg 57 interconnecting long leg 53 and short leg 55. J-shaped hooks 45-3 and 45-4 are arranged so that their fixed ends 54 are proximate to side edges 31-2 and 31-1, respectively, and so that their free ends 56 are distal to side edges 31-2 and 31-1, respectively. Through-cut 44-1 have a pair of terminal ends 60-1 and 60-2, and through-cut 44-3 have a pair of terminal ends 62-1 and 62-2. Each of terminal ends 60-1, 60-2, 62-1, and 62-2 is a crescent-shaped cut that curls upwardly and towards side 31-1. Each of terminal ends 60-1, 60-2, and 62-1 is spaced substantially the same distance from side edge 31-2, with terminal end 62-2 (also referred to as the lower terminal end of J-shaped hook 45-3) being spaced substantially closer to side edge 31-2 than are terminal ends 60-1 and 60-2 of J-shaped hook 45-1, and terminal end 62-1 (also referred to as the upper terminal end of J-shaped hook 45-3). Similarly, through-cut 44-2 have a pair of terminal ends 64-1 and 64-2, and through-cut 44-4 have a pair of terminal ends 66-1 and 66-2. Each of terminal ends 64-1, 64-2, 66-1, and 66-2 is a crescent-shaped cut that curls upwardly and towards side 31-2. Each of terminal ends 64-1, 64-2, and 66-1 is spaced substantially the same distance from side edge 31-1, with terminal end 66-2 being spaced substantially closer to side edge 31-1 than are terminal ends 64-1, 64-2, and 66-1. The closer spacing of terminal ends 62-2 and 66-2 to side edges 31-2 and 31-1, respectively, can serve to minimize the likelihood that back panel 21 may tear when front folder 13 is telescoped away from middle folder 15-1.

Cover flap 23 is integrally formed with back panel 21 and is hingedly connected to top edge 41 of panel 21 at a fold line 69. Cover flap 23 is centered relative to back panel 21 and tapers in length from a maximum length l₁ at fold line 69 to a minimum length l₂ at a bottom edge 73, with maximum length l₁ being substantially less than the length l₃ of back panel 21. In addition, cover flap 23 has a width w₁ that is substantially less than the corresponding width w₂ of back panel 21. As will be discussed further below, cover flap 23 can be inserted into the pocket of middle folder 15-1 and, thus inserted, can minimize the likelihood that a user may inadvertently insert an item into the space between front folder 13 and middle folder 15-1.

In one embodiment, length l₃ is approximately 11⅝ inches and width w₂ is approximately 9⅛ inches. In alternate embodiments, length l₃ and width w₂ can be varied to accommodate a variety of different-sized articles, for example, legal-sized or A4-sized sheets of paper or media, file folders, or hanging file folders.

Front folder 13 further includes a knob 75. Knob 75 includes a pedestal portion 77 of comparatively smaller diameter secured at one end to front panel 19 and a disc portion 79 of comparatively greater diameter secured at the opposite end of pedestal portion 77. As will be discussed further below, knob 75 serves as a part of a closure mechanism for folder assembly 11.

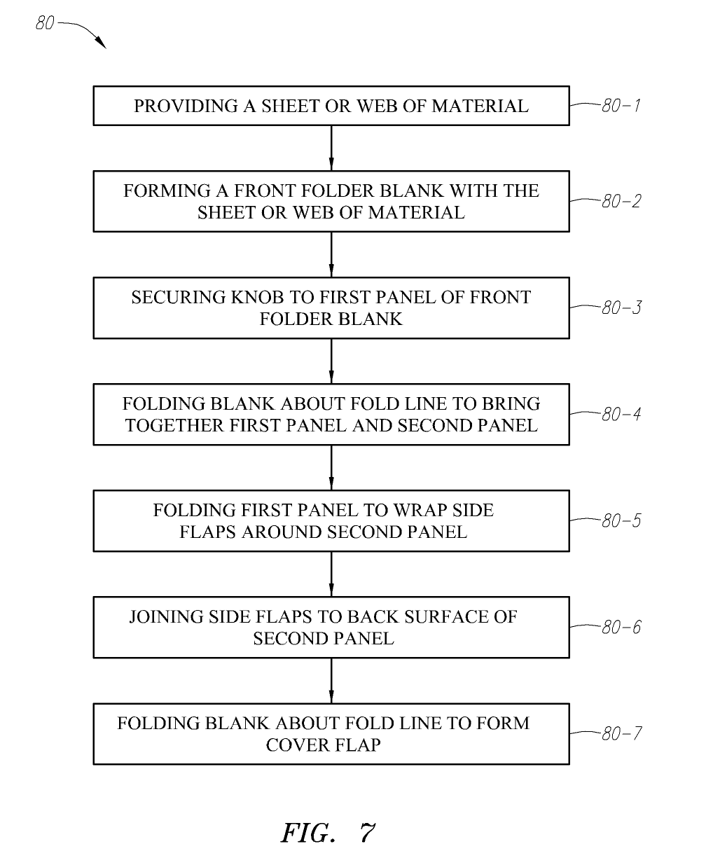

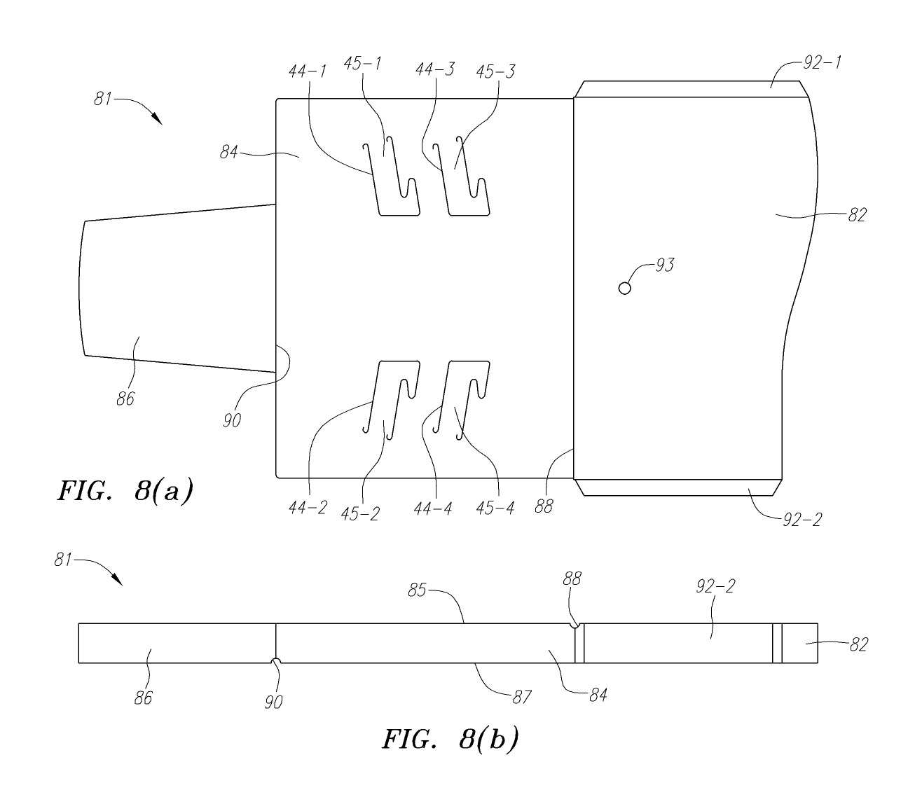

Referring now to FIG. 7, there is shown a flowchart, schematically depicting one method for manufacturing front folder 13, said method being represented generally by reference numeral 80. Method 80 begins in a step 80-1 with providing a sheet or web of material, such as, for example, a sheet or web of coated or uncoated cardstock, a sheet or web of polypropylene, or a sheet or web of a similarly suitable material. If a polypropylene sheet or web is used, such a sheet or web can have a thickness of approximately 0.3 mm. Alternatively, the thickness of the sheet or web of material can range from approximately 0.3 mm to approximately 0.4 mm, or from approximately 0.2 mm to approximately 0.8 mm. Method 80 continues with a step 80-2 of forming a front folder blank, wherein step 80-2 can include die-cutting the sheet or web of material to form an outline of the front folder blank, die-cutting J-shaped hooks and a knob opening in the outline, and scoring fold lines in the outline. Such die-cutting and scoring can be performed all at once or in steps. An embodiment of a front folder blank formed using steps 80-1 and 80-2 is shown in FIGS. 8(a) and 8(b) and is represented by reference numeral 81. Blank 81 includes a first panel 82, a second panel 84, and a third panel 86, with first panel 82 and second panel 84 being interconnected by a fold line 88 and with second panel 84 and third panel 86 being interconnected by a fold line 90. First panel 82 is shaped to include a pair of side flaps 92-1 and 92-1 and a transverse opening 93 for receiving knob 75. Second panel 84 includes through-cuts 44-1 through 44-4 defining J-shaped hooks 45-1 through 45-4, respectively. Method 80 continues with a step 80-3 of securing knob 75 to first panel 82. Method 80 continues with a step 80-4 of folding blank 81 about fold line 88 until first panel 82 is positioned against a front surface 85 of second panel 84. Method 80 continues with a step 80-5 of folding side flaps 92-1 and 92-2 inwardly until they are flush against a back surface 87 of second panel 84. Method 80 continues with a step 80-6 of welding side flaps 92-1 and 92-2 to back surface 87, whereby front panel 19 and back panel 21 are formed from first panel 82 and second panel 84, respectively. Finally, method 80 concludes with a step 80-7 of folding third panel 86 rearwardly about fold line 90 to form cover flap 23.

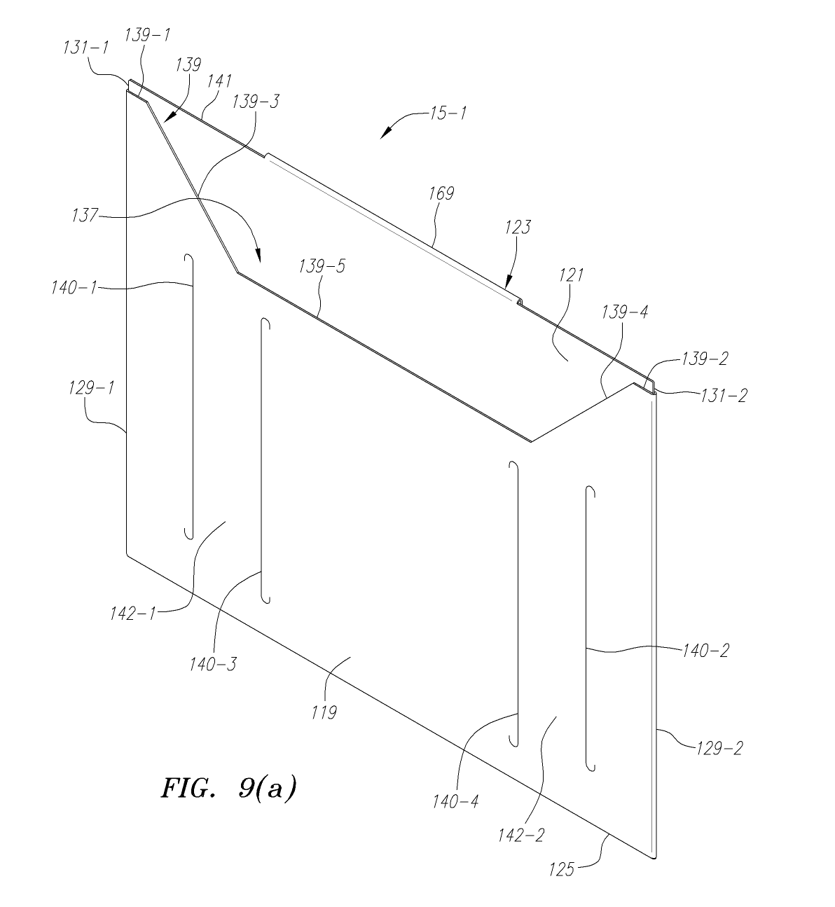

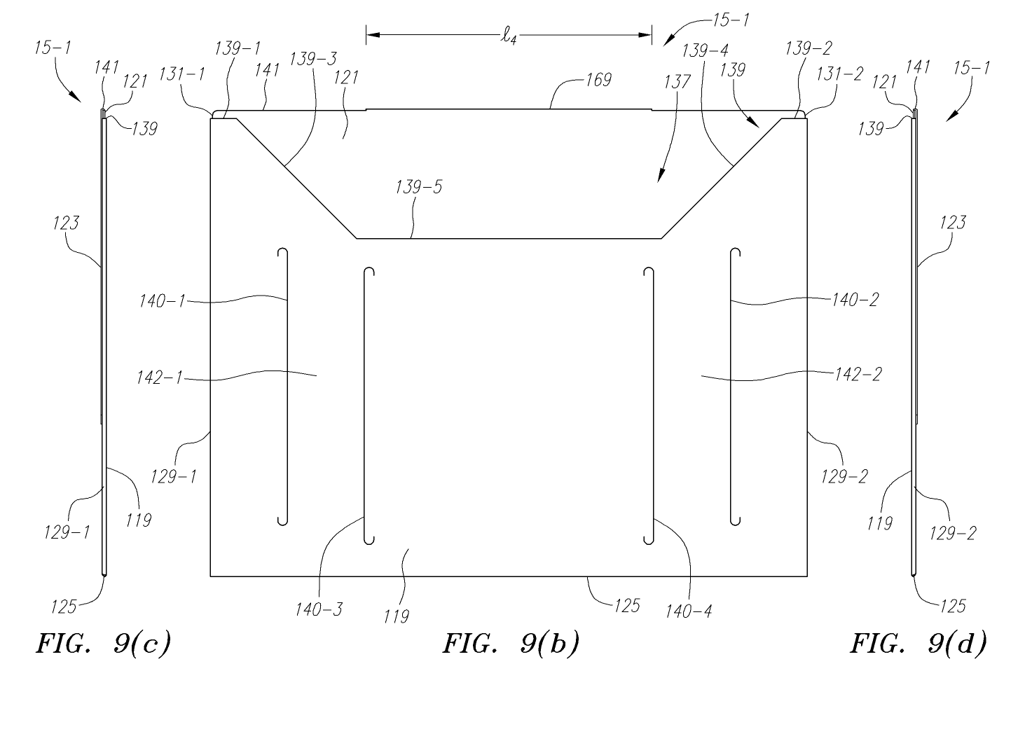

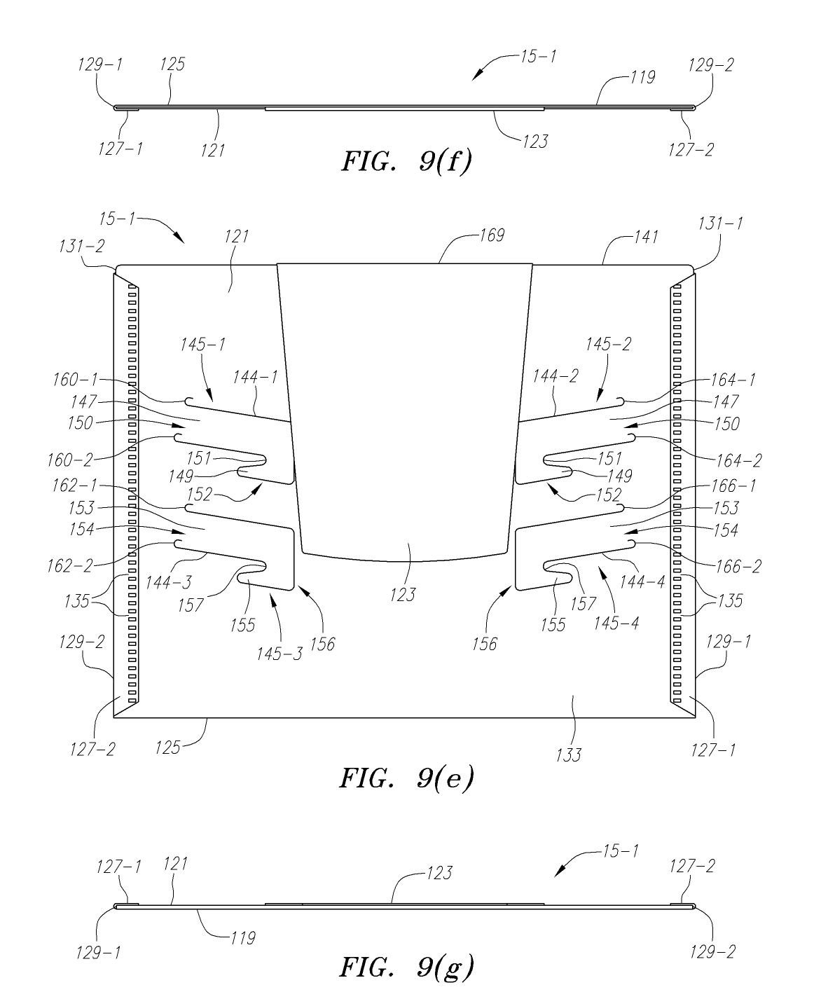

Referring now to FIGS. 9(a) through 9(g), there are shown various views of middle folder 15-1, it being understood that middle folders 15-2 and 15-3 can be identical in construction to middle folder 15-1. Middle folder 15-1 includes a front panel 119, a back panel 121, and a cover flap 123. Front panel 119 and back panel 121 are interconnected at their respective bottom edges by a fold line 125. In addition, a pair of side flaps 127-1 and 127-2, which are integrally formed with the right and left side edges 129-1 and 129-2, respectively, of front panel 119, are folded around the right and left side edges 131-1 and 131-2, respectively, of back panel 121 and are joined to the back surface 133 of back panel 121 by a plurality of welds 135. In this manner, front panel 119 and back panel 121 jointly define a pocket 137 having an open top.

Front panel 119 has a top edge 139 that is spaced downwardly relative to a top edge 141 of back panel 121 to enable the viewing of a portion of a document or other appropriately sized item disposed within pocket 137, thereby facilitating a user in the identification of the contents of pocket 137 without requiring the user to remove the contents from pocket 137. In addition, because top edge 139 is spaced downwardly relative to top edge 141, one can position an appropriately dimensioned label or other indicia on the front surface of back panel 121 without having the same obscured from view by front panel 119. Top edge 139 is shaped to include a pair of level end portions 139-1 and 139-2, a pair of angled portions 139-3 and 139-4 sloping downwardly from end portions 139-1 and 139-2, respectively, and a level center portion 139-5 interconnecting angled portions 139-3 and 139-4. Center portion 139-5 has a length l₄ that is dimensioned to matingly receive the length of fold line 69 of front folder 13 so that, with cover flap 23 of front folder 13 is inserted into pocket 137 of middle folder 15-1 and with folders 13 and 15-1 telescoped away from each other, fold line 69 can mate with and can rest upon center portion 139-5.

Front panel 119 further includes a plurality of through-cuts 140-1 through 140-4. Through-cuts 140-1 through 140-4 are arranged on front panel 119 in two sets of two, with through-cuts 140-1 and 140-3 jointly defining a strap 142-1 and with through-cuts 140-2 and 140-4 jointly defining a strap 142-2. Straps 142-1 and 142-2 are symmetrically arranged on front panel 119 so as to extend generally parallel to one another and generally parallel to side edges 129-1 and 129-2 and so as to be positioned between fold line 125 and top edge 139. As will be discussed further below, together with J-shaped hooks 45-1 through 45-4, straps 142-1 and 142-2 include a mechanism for coupling front folder 13 to middle folder 15-1 to enable telescopic movement therebetween. As such, strap 142-1 are appropriately positioned and dimensioned so that J-shaped hooks 45-2 and 45-4 are slidably mounted thereon, and strap 142-2 are appropriately positioned and dimensioned so that J-shaped hooks 45-1 and 45-3 are slidably mounted thereon. (As can readily be appreciated, if the number and/or arrangement of J-shaped hooks 45-1 through 45-4 is modified, the number and/or arrangement of straps 142-1 and 142-2 can be modified correspondingly.) Through-cuts 140-1 and 140-3 are staggered vertically relative to one another, with the top end of through-cut 140-1 being positioned closer to top edge 139 than is the top end of through-cut 140-3 and with the bottom end of through-cut 140-3 being positioned closer to fold line 125 than is the bottom end of through-cut 140-1, so as to correspond to the above-mentioned downward angling of J-shaped hooks 45-2 and 45-4. Similarly, through-cuts 140-2 and 140-4 are staggered vertically relative to one another, with the top end of through-cut 140-2 being positioned closer to top edge 139 than is the top end of through-cut 140-4 and with the bottom end of through-cut 140-4 being positioned closer to fold line 125 than is the bottom end of through-cut 140-2, so as to correspond to the above-mentioned downward angling of J-shaped hooks 45-1 and 45-3. To minimize tearing of through-cuts 140-1 and 140-3 by J-shaped hooks 45-2 and 45-4, the respective top and bottom ends of through-cuts 140-1 and 140-3 are curled away from strap 142-1. Similarly, to minimize tearing of through-cuts 140-2 and 140-4 by J-shaped hooks 45-1 and 45-3, the respective top and bottom ends of through-cuts 140-2 and 140-4 are curled away from strap 142-2.

Back panel 121 includes a plurality of through-cuts 144-1 through 144-4 defining a corresponding plurality of J-shaped hooks 145-1 through 145-4, respectively. J-shaped hooks 145-1 through 145-4 include a part of a mechanism for coupling middle folder 15-1 to middle folder 15-2 to enable telescopic movement therebetween. J-shaped hooks 145-1 through 145-4 are symmetrically arranged on back panel 121 in two columns of two, with J-shaped hooks 145-1 and 145-2 being mirror images of one another and with J-shaped hooks 145-3 and 145-4 being mirror images of one another. (It is to be understood that the number and arrangement of J-shaped hooks 145-1 through 145-4 in the present embodiment is merely illustrative and that there may be a greater number or lesser number of J-shaped hooks 145-1 through 145-4 and/or that these J-shaped hooks may be arranged in a different fashion.) J-shaped hooks 145-1 through 145-4 are preferably angled downwardly slightly (e.g., 10 degrees) towards fold line 125 to reduce the likelihood that paper or other items inserted into pocket 137 may become caught in cuts 144-1 through 144-4. Each of J-shaped hooks 145-1 and 145-2 includes a long leg 147 fixed at one end to back panel 121, a short leg 149 generally parallel to long leg 147, and a transverse leg 151 interconnecting long leg 147 and short leg 149. J-shaped hooks 145-1 and 145-2 are arranged so that their fixed ends 150 are proximate to side edges 131-2 and 131-1, respectively, and so that their free ends 152 are distal to side edges 131-2 and 131-1, respectively. Similarly, each of J-shaped hooks 145-3 and 145-4 includes a long leg 153 fixed at one end to back panel 121, a short leg 155 generally parallel to long leg 147, and a transverse leg 157 interconnecting long leg 153 and short leg 155. J-shaped hooks 145-3 and 145-4 are arranged so that their fixed ends 154 are proximate to side edges 131-2 and 131-1, respectively, and so that their free ends 156 are distal to side edges 131-2 and 131-1, respectively. Through-cut 144-1 have a pair of terminal ends 160-1 and 160-2, and through-cut 144-3 have a pair of terminal ends 162-1 and 162-2. Each of terminal ends 160-1, 160-2, 162-1, and 162-2 is a crescent-shaped cut that curls upwardly and towards side 131-1. Each of terminal ends 160-1, 160-2, and 162-1 is spaced substantially the same distance from side edge 131-2, with terminal end 162-2 being spaced substantially closer to side edge 131-2 than are terminal ends 160-1, 160-2, and 162-1. Similarly, through-cut 144-2 have a pair of terminal ends 164-1 and 164-2, and through-cut 144-4 have a pair of terminal ends 166-1 and 166-2. Each of terminal ends 164-1, 164-2, 166-1, and 166-2 is a crescent-shaped cut that curls upwardly and towards side 131-2. Each of terminal ends 164-1, 164-2, and 166-1 is spaced substantially the same distance from side edge 131-1, with terminal end 166-2 being spaced substantially closer to side edge 131-1 than are terminal ends 164-1, 164-2, and 166-1. The closer spacing of terminal ends 162-2 and 166-2 to side edges 131-2 and 131-1, respectively, can serve to minimize the likelihood that back panel 121 may tear when middle folder 15-1 is telescoped away from middle folder 15-2.

Cover flap 123 is integrally formed with back panel 121 and hingedly connected to top edge 141 of panel 121 at a fold line 169. Cover flap 123 is centered relative to back panel 121 and is shaped similarly to cover flap 23 of front folder 13. Cover flap 123 can be inserted into the pocket of the folder directly behind it, which, in this case, can be middle folder 15-2 and, thus inserted, can minimize the likelihood that a user may inadvertently insert an item into the space between middle folder 15-1 and middle folder 15-2.

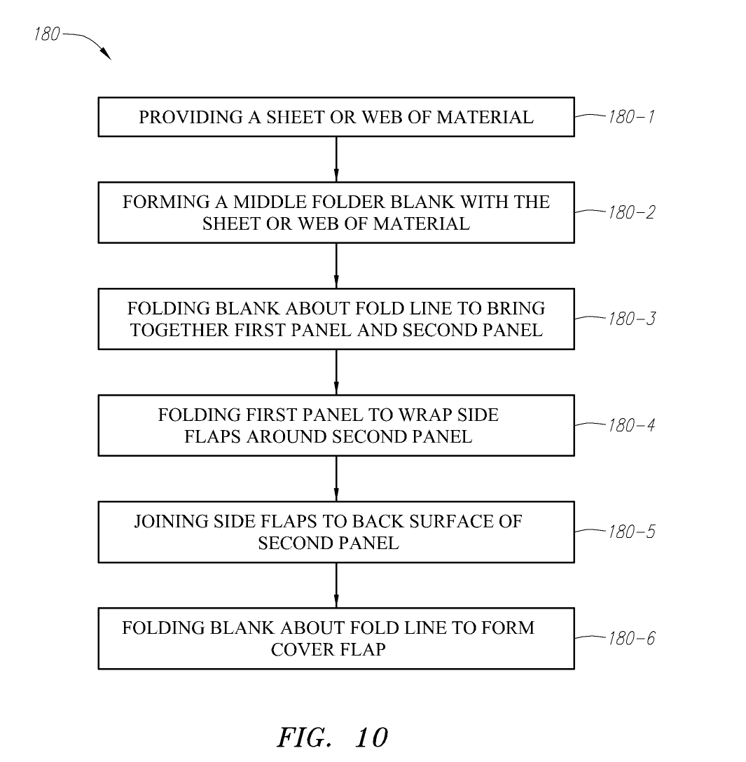

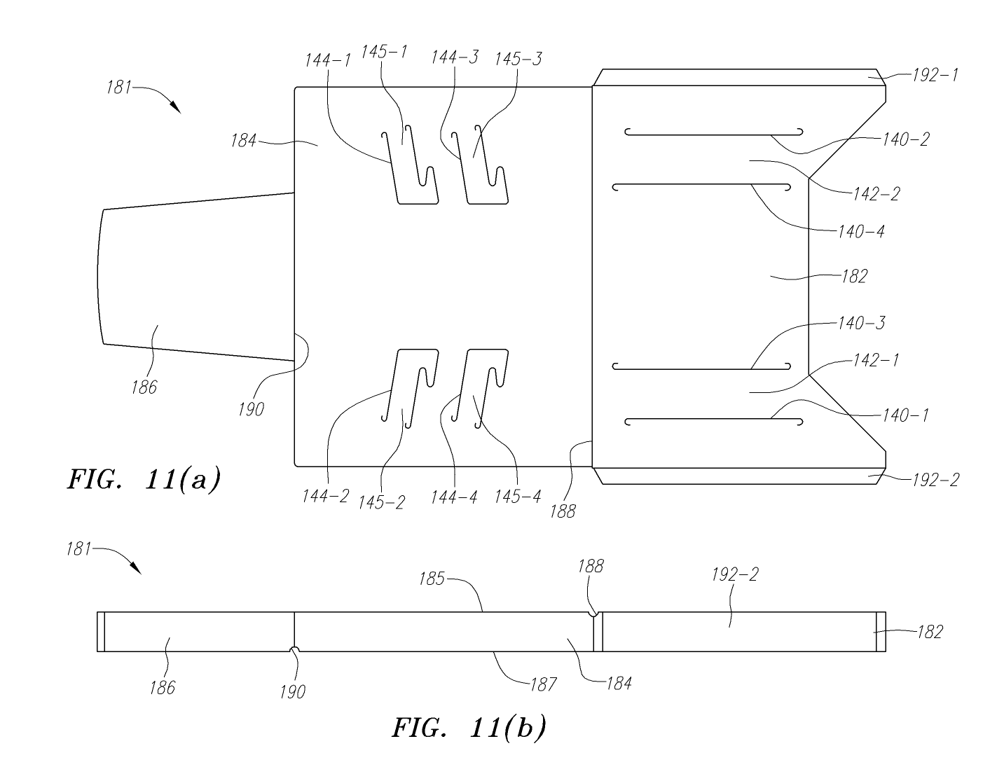

Referring now to FIG. 10, there is shown a flowchart, schematically depicting one method for manufacturing middle folder 15-1, said method being represented generally by reference numeral 180. Method 180 begins in a step 180-1 with providing a sheet or web of material, such as, for example, a sheet or web of coated or uncoated cardstock, a sheet or web of polypropylene, or a sheet or web of a similarly suitable material. If a polypropylene sheet or web is used, such a sheet or web can have a thickness of approximately 0.3 mm. Method 180 continues with a step 180-2 of forming a middle folder blank, wherein step 180-2 can include die-cutting the sheet or web of material to form an outline of the middle folder, die-cutting J-shaped hooks and straps in the outline, and scoring fold lines in the outline. Such die-cutting and scoring can be performed all at once or in steps. An embodiment of a middle folder blank formed using steps 180-1 and 180-2 is shown in FIGS. 11(a) and 11(b) and is represented by reference numeral 181. Blank 181 is cut and scored to define a first panel 182, a second panel 184, and a third panel 186, with first panel 182 and second panel 184 being interconnected by a fold line 188 and with second panel 184 and third panel 186 being interconnected by a fold line 190. First panel 182 is shaped to include a pair of side flaps 192-1 and 192-1 and also is shaped/configured to include through-cuts 140-1 and 140-3 defining strap 142-1 and through-cuts 140-2 and 140-4 defining strap 142-2. Second panel 184 is shaped/configured to include through-cuts 144-1 through 144-4 defining J-shaped hooks 145-1 through 145-4, respectively. Method 180 continues with a step 180-3 of folding blank 181 about fold line 188 until first panel 182 is positioned against a front surface 185 of second panel 184. Method 180 continues with a step 180-4 of folding side flaps 192-1 and 192-2 inwardly until they are flush against a back surface 187 of second panel 184. Method 180 continues with a step 180-5 of welding side flaps 192-1 and 192-2 to back surface 187, whereby front panel 119 and back panel 121 are formed from first panel 182 and second panel 184, respectively. Finally, method 180 concludes with a step 180-6 of folding third panel 186 rearwardly about fold line 190 to form cover flap 123.

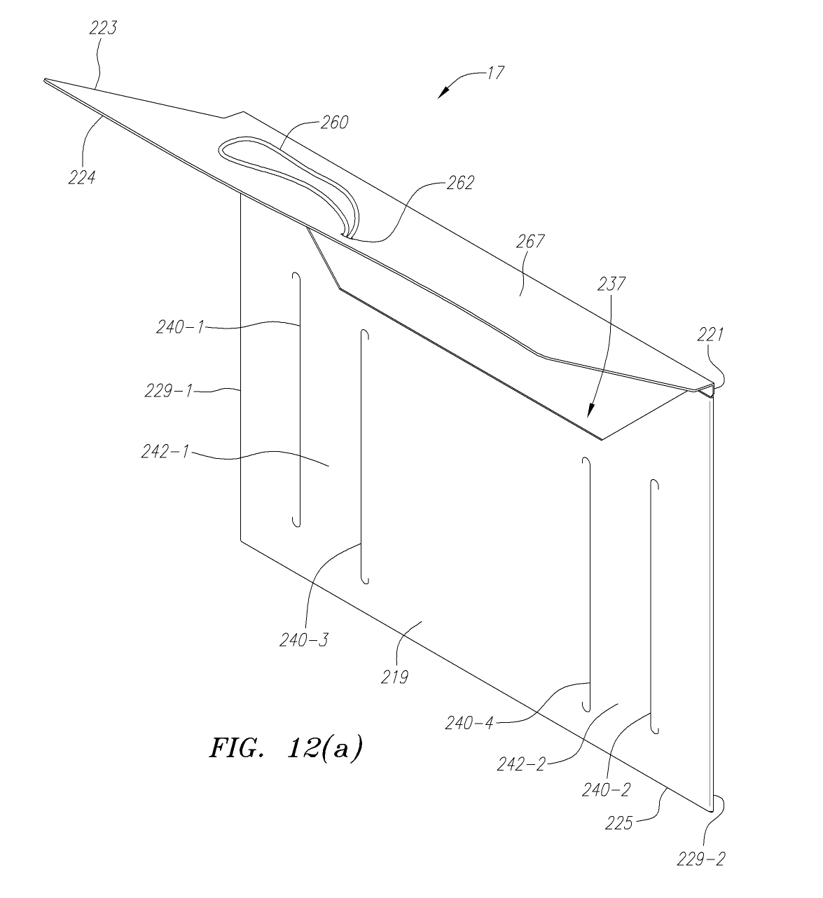

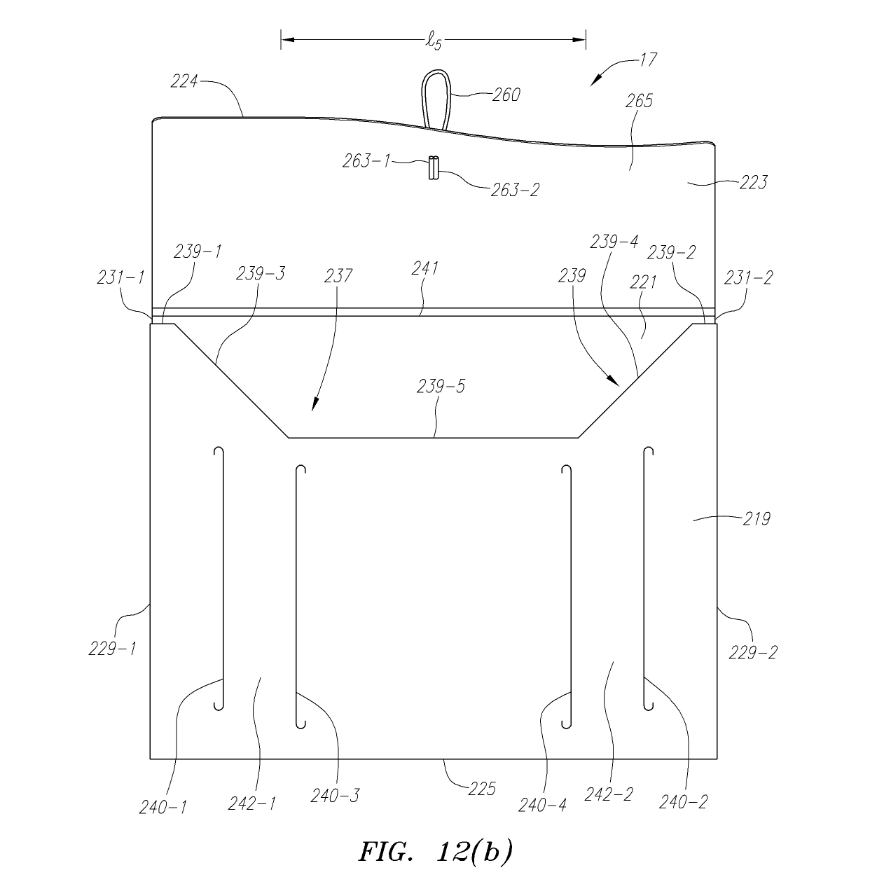

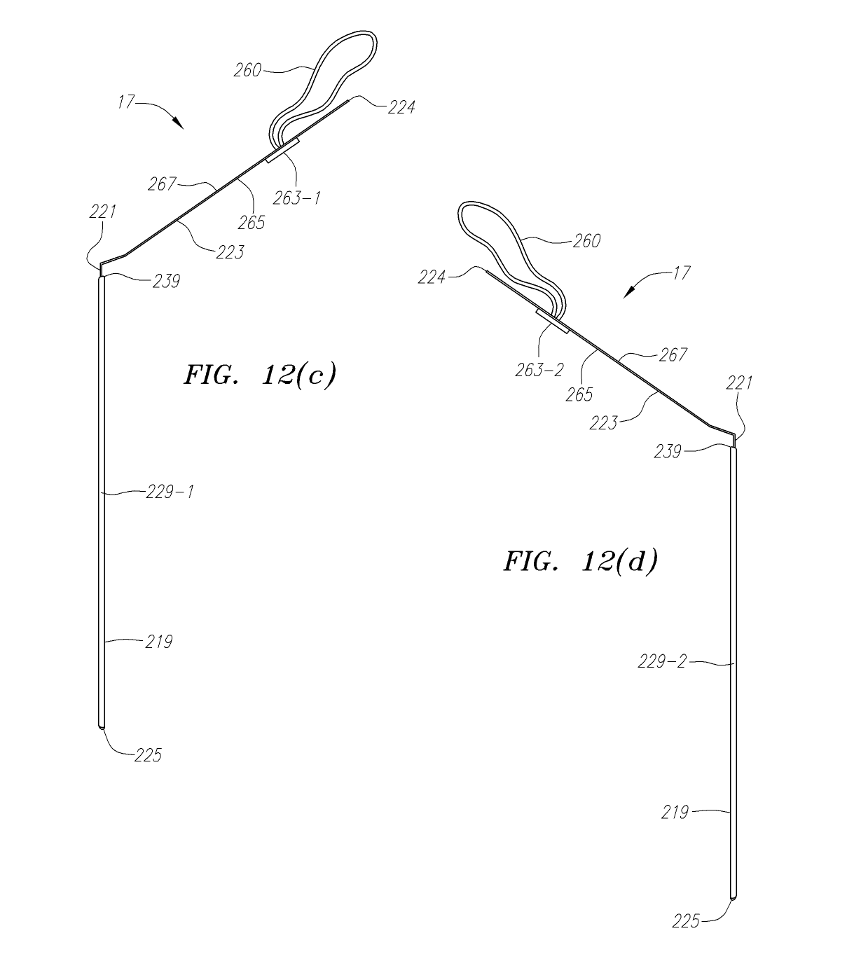

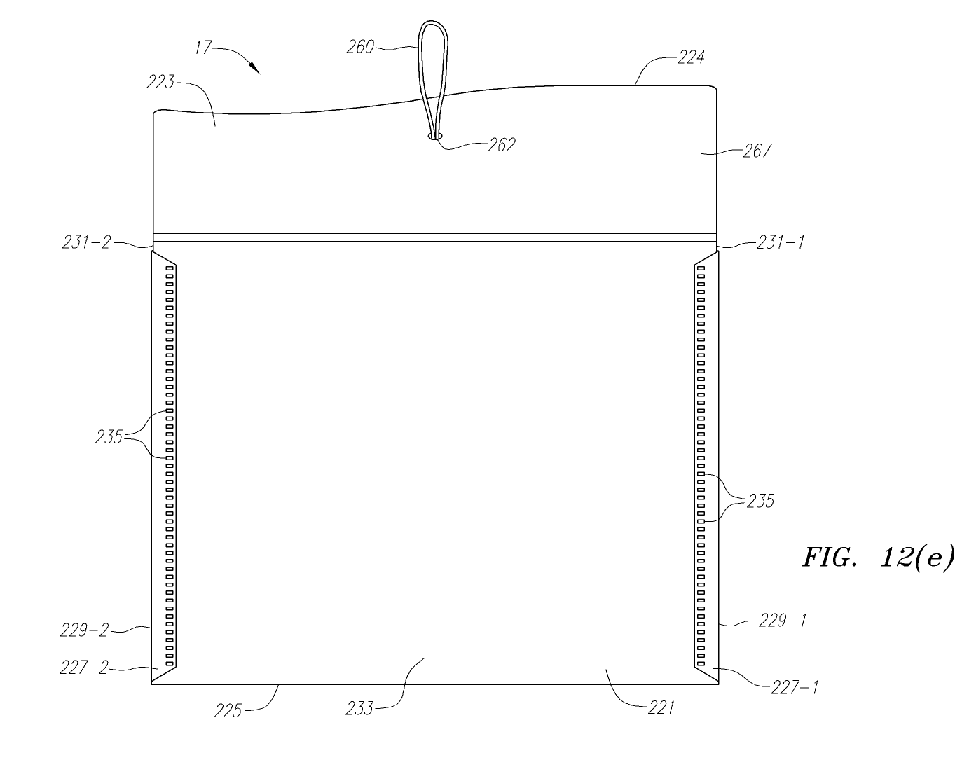

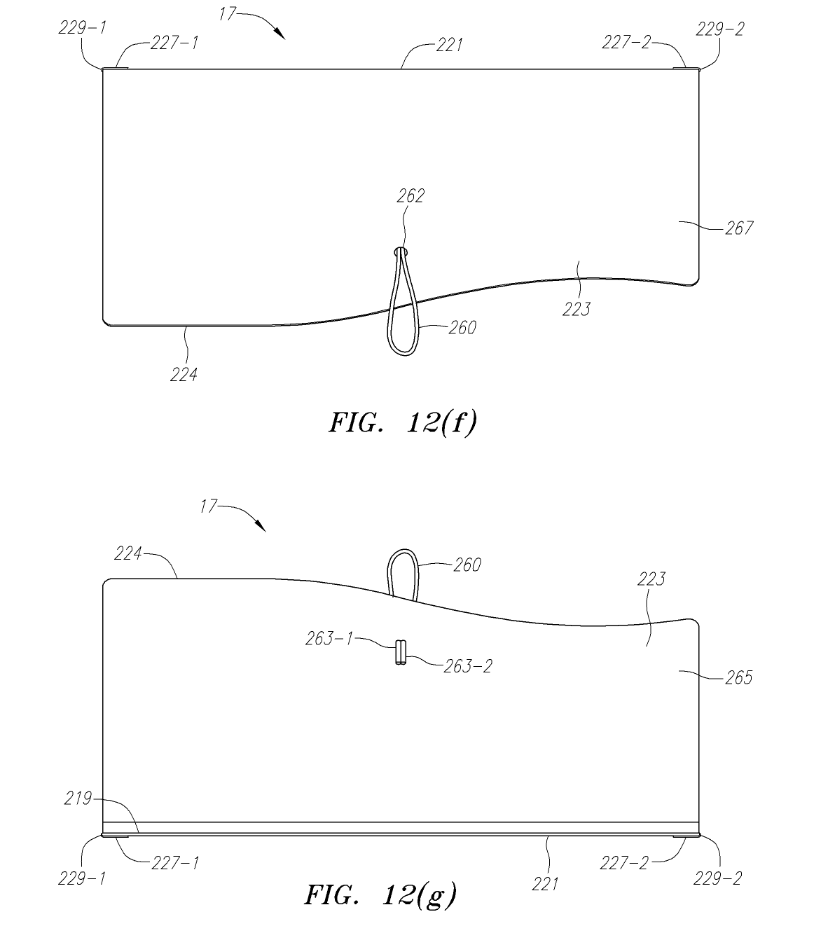

Referring now to FIGS. 12(a) through 12(g), there are shown various views of rear folder 17. Rear folder 17 includes a front panel 219, a back panel 221, and a cover flap 223. Front panel 219 and back panel 221 are interconnected at their respective bottom edges by a fold line 225. In addition, a pair of side flaps 227-1 and 227-2, which is integrally formed with the right and left side edges 229-1 and 229-2, respectively, of front panel 219, is folded around the right and left side edges 231-1 and 231-2, respectively, of back panel 221 and are joined to the back surface 233 of back panel 221 by a plurality of welds 235. In this manner, front panel 219 and back panel 221 jointly define a pocket 237 having an open top.

Front panel 219 has a top edge 239 that is spaced downwardly relative to a top edge 241 of back panel 221 to enable the viewing of a portion of a document or other appropriately sized item disposed within pocket 237, thereby facilitating a user in the identification of the contents of pocket 237 without requiring the user to remove the contents from pocket 237. In addition, because top edge 239 is spaced downwardly relative to top edge 241, one can position an appropriately dimensioned label or other indicia on the front surface of back panel 221 without having the same obscured from view by front panel 219. Top edge 239 is shaped to include a pair of level end portions 239-1 and 239-2, a pair of angled portions 239-3 and 239-4 sloping downwardly from end portions 239-1 and 239-2, respectively, and a level center portion 239-5 interconnecting angled portions 239-3 and 239-4. Center portion 239-5 has a length l₅ that is dimensioned to matingly receive the length of fold line 169 of middle folder 15-3 so that, with cover flap 123 of middle folder 15-3 inserted into pocket 237 of rear folder 17 and with folders 15-3 and 17 telescoped away from each other, fold line 169 can mate with and can rest upon center portion 239-5.

Front panel 219 further includes a plurality of through-cuts 240-1 through 240-4. Through-cuts 240-1 through 240-4 are arranged on front panel 219 in two sets of two, with through-cuts 240-1 and 240-3 jointly defining a strap 242-1 and with through-cuts 240-2 and 240-4 jointly defining a strap 242-2. Straps 242-1 and 242-2 are symmetrically arranged on front panel 219 so as to extend generally parallel to one another and generally parallel to side edges 229-1 and 229-2 and so as to be positioned between fold line 225 and top edge 239. Together with J-shaped hooks 145-1 through 145-4 of middle folder 15-3, straps 242-1 and 242-2 include the mechanism for coupling middle folder 15-3 to rear folder 17 to enable telescopic movement therebetween. As such, strap 242-1 is appropriately positioned and dimensioned so that J-shaped hooks 145-2 and 145-4 are slidably mounted thereon, and strap 242-2 are appropriately positioned and dimensioned so that J-shaped hooks 145-1 and 145-3 are slidably mounted thereon. (As can readily be appreciated, if the number and/or arrangement of J-shaped hooks 145-1 through 145-4 on middle folder 15-3 is modified, the number and/or arrangement of straps 242-1 and 242-2 can be modified correspondingly.) Through-cuts 240-1 and 240-3 are staggered vertically relative to one another, with the top end of through-cut 240-1 being positioned closer to top edge 239 than is the top end of through-cut 240-3 and with the bottom end of through-cut 240-3 being positioned closer to fold line 225 than is the bottom end of through-cut 240-1, so as to correspond to the above-mentioned downward angling of J-shaped hooks 145-2 and 145-4. Similarly, through-cuts 240-2 and 240-4 are staggered vertically relative to one another, with the top end of through-cut 240-2 being positioned closer to top edge 239 than is the top end of through-cut 240-4 and with the bottom end of through-cut 240-4 being positioned closer to fold line 225 than is the bottom end of through-cut 240-2, so as to correspond to the above-mentioned downward angling of J-shaped hooks 145-1 and 145-3. To minimize tearing of through-cuts 240-1 and 240-3 by J-shaped hooks 145-2 and 145-4, the respective top and bottom ends of through-cuts 240-1 and 240-3 are curled away from strap 242-1. Similarly, to minimize tearing of through-cuts 240-2 and 240-4 by J-shaped hooks 145-1 and 145-3, the respective top and bottom ends of through-cuts 240-1 and 240-3 are curled away from strap 242-2.

Cover flap 223 is integrally formed with back panel 221 and is hingedly connected to top edge 241 of panel 221. Cover flap 223 is dimensioned so that, when cover flap 223 is closed over front folder 13, cover flap 223 extends downwardly past top edge 39 of front folder 13, thereby covering pocket 37 of front folder 13. It should be understood that, although the free edge 224 of cover flap 223 is shown in the present embodiment as including a curved wave-like shape, edge 224 need not be so shaped.

Rear folder 17 further includes an elastic strap 260 looped through a transverse opening 262 in cover flap 223. A first transverse bar 263-1 is secured at one end of strap 260, and a second transverse bar 263-2 is secured at the opposite end of strap 260. Transverse bars 263-1 and 263-2 are appropriately dimensioned to minimize the likelihood that the ends of strap 260 may be pulled from an interior side 265 of cover flap 223 through opening 262 to the exterior side 267 of cover flap 223. Strap 260 can be stretched and looped around pedestal portion 77 of knob 75 so as to maintain folder assembly 11 in a closed and compacted state.

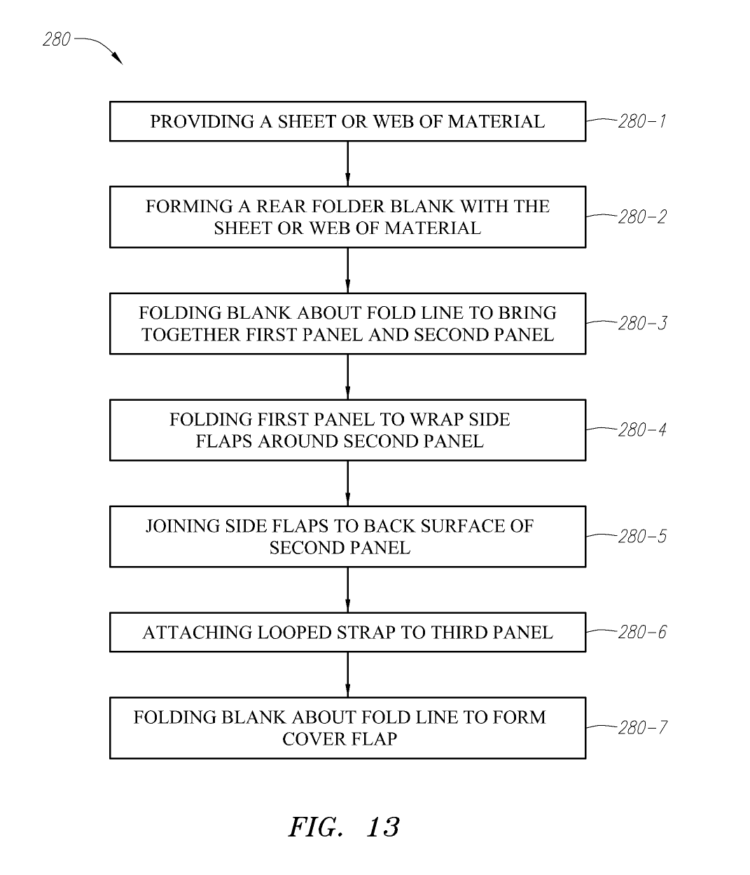

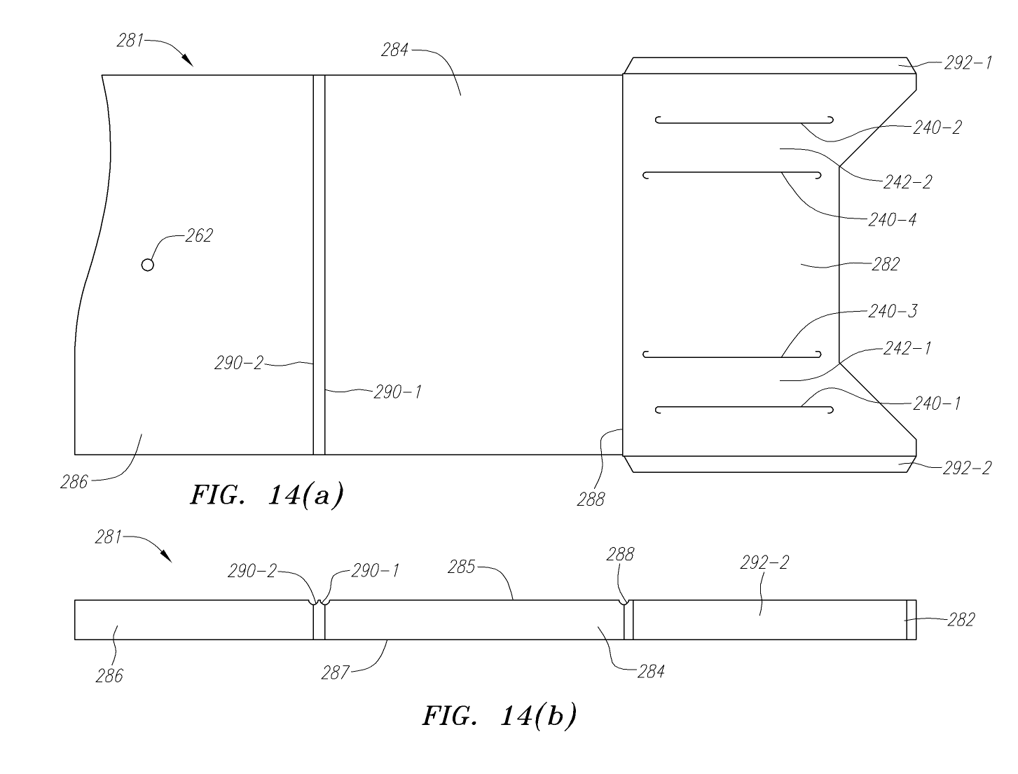

Referring now to FIG. 13, there is shown a flowchart, schematically depicting one method for manufacturing rear folder 17, said method being represented generally by reference numeral 280. Method 280 begins in a step 280-1 with providing a sheet or web of material, such as, for example, a sheet or web of coated or uncoated cardstock, a sheet or web of polypropylene, or a sheet or web of a similarly suitable material. If a polypropylene sheet or web is used, such a sheet or web can have a thickness of approximately 0.3 mm. Method 280 continues with a step 280-2 of forming a rear folder blank, wherein step 280-2 can include die-cutting the sheet or web of material to form an outline of the rear folder, die-cutting straps and a strap opening in the outline, and scoring fold lines in the outline. Such die-cutting and scoring can be performed all at once or in steps. An embodiment of a rear folder blank formed using steps 280-1 and 280-2 is shown in FIGS. 14(a) and 14(b) and is represented by reference numeral 281. Blank 281 are cut and scored to define a first panel 282, a second panel 284, and a third panel 286, with first panel 282 and second panel 284 being interconnected by a fold line 288 and with second panel 284 and third panel 286 being interconnected by a pair of parallel fold lines 290-1 and 290-2. First panel 282 is shaped to include a pair of side flaps 292-1 and 292-1 and is also shaped/configured to include through-cuts 240-1 and 240-3 defining strap 242-1 and through-cuts 240-2 and 240-4 defining strap 242-2. Third panel 286 is shaped/configured to include opening 262 for receiving strap 260. Method 280 continues with a step 280-3 of folding blank 281 about fold line 288 until first panel 282 is positioned against a front surface 285 of second panel 284. Method 280 continues with a step 280-4 of folding side flaps 292-1 and 292-2 inwardly until they are positioned against a back surface 287 of second panel 284. Method 280 continues with a step 280-5 of welding side flaps 292-1 and 292-2 to back surface 287, whereby front panel 219 and back panel 221 are formed from first panel 282 and second panel 284, respectively. Method 280 continues with a step 280-6 of attaching strap 260 to third panel 286. Finally, method 280 concludes with a step 280-7 of folding third panel 286 forwardly about fold lines 290-1 and 290-2 to form cover flap 223.

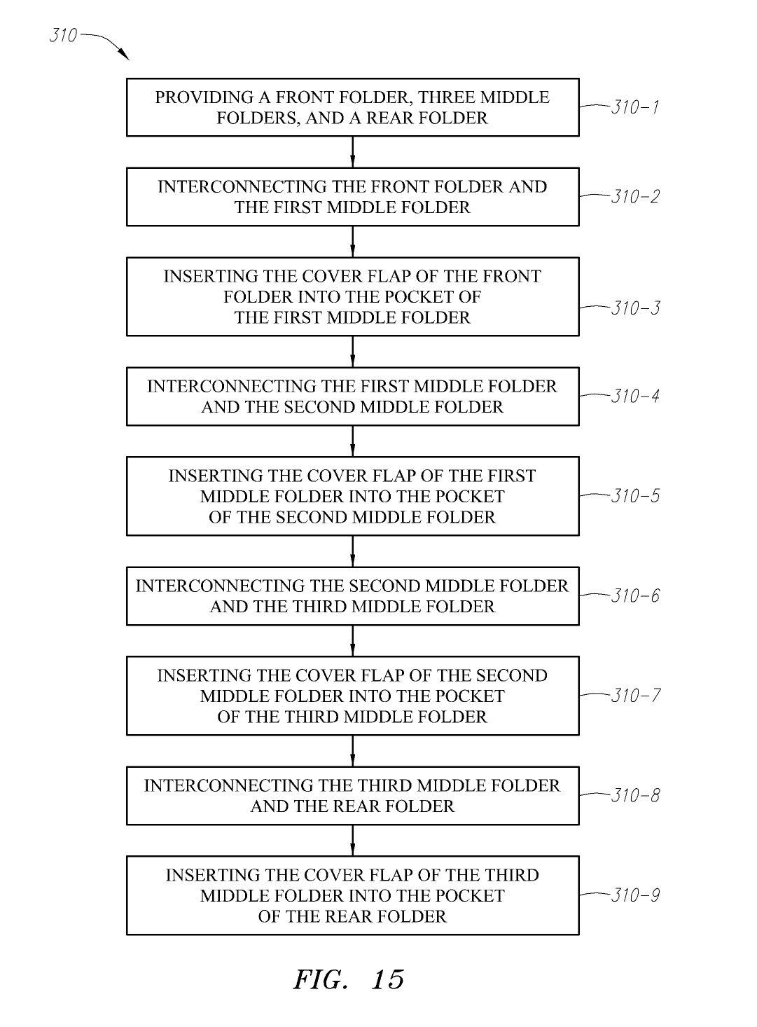

Referring now to FIG. 15, there is shown a flowchart, schematically depicting one method for assembling folder assembly 11, said method being represented generally by reference numeral 310. Method 310 begins in a step 310-1 with providing folders 13, 15-1 through 15-3, and 17. Method 310 continues with a step 310-2 of telescopically interconnecting front folder 13 and middle folder 15-1. Such interconnecting of front folder 13 and middle folder 15-1 includes weaving J-shaped hooks 45-2 and 45-4 onto strap 142-1 and weaving J-shaped hooks 45-1 and 45-3 onto strap 142-2. Each of J-shaped hooks 45-1 and 45-2 is woven onto straps 142-2 and 142-1, respectively, by passing the free end 52 of each of J-shaped hooks 45-1 and 45-2 behind its respective strap 142 and then hooking the free end 52 of each of J-shaped hooks 45-1 and 45-2 around the side edge of its respective strap 142, whereby each long leg 47 is positioned largely behind its respective strap 142 and each short leg 49 is positioned largely in front of its respective strap 142. Similarly, each of J-shaped hooks 45-3 and 45-4 is woven onto straps 142-2 and 142-1, respectively, by passing the free end 56 of each of J-shaped hooks 45-3 and 45-4 behind its respective strap 142 and then hooking the free end 56 of each of J-shaped hooks 45-3 and 45-4 around the side edge of its respective strap 142, whereby each long leg 53 is positioned largely behind its respective strap 142 and each short leg 55 is positioned largely in front of its respective strap 142. The above-described weaving of J-shaped hooks 45-1 through 45-4 onto their respective straps 142 can be done one at a time, in any sequence, or can be done simultaneously with two or more of J-shaped hooks 45-1 through 45-4. Method 310 continues with a step 310-3 of inserting cover flap 23 of front folder 13 into pocket 137 of middle folder 15-1. Method 310 continues with a step 310-4 of telescopically interconnecting middle folder 15-1 and middle folder 15-2. Such interconnecting of middle folder 15-1 and middle folder 15-2 includes weaving J-shaped hooks 145-2 and 145-4 of middle folder 15-1 onto strap 142-1 of middle folder 15-2 and weaving J-shaped hooks 145-1 and 145-3 of middle folder 15-1 onto strap 142-2 of middle folder 15-2. The weaving of J-shaped hooks 145-1 through 145-4 onto their respective straps 142 can be done in an analogous fashion to that described above in connection with J-shaped hooks 45-1 through 45-4 of front folder 13 and straps 142-1 and 142-2 of middle folder 15-1. Method 310 continues with a step 310-5 of inserting cover flap 123 of middle folder 15-1 into pocket 137 of middle folder 15-2. Method 310 continues with a step 310-6 of telescopically interconnecting middle folder 15-2 and middle folder 15-3. Such interconnecting of middle folder 15-2 and middle folder 15-3 includes weaving J-shaped hooks 145-2 and 145-4 of middle folder 15-2 onto strap 142-1 of middle folder 15-3 and weaving J-shaped hooks 145-1 and 145-3 of middle folder 15-2 onto strap 142-2 of middle folder 15-3. The weaving of J-shaped hooks 145-1 through 145-4 onto their respective straps 142 can be done in an analogous fashion to that described above in connection with J-shaped hooks 45-1 through 45-4 of front folder 13 and straps 142-1 and 142-2 of middle folder 15-1. Method 310 continues with a step 310-7 of inserting cover flap 123 of middle folder 15-2 into pocket 137 of middle folder 15-3. Method 310 continues with a step 310-8 of telescopically interconnecting middle folder 15-3 and rear folder 17. Such interconnecting of middle folder 15-3 and rear folder 17 includes weaving J-shaped hooks 145-2 and 145-4 of middle folder 15-3 onto strap 242-1 of rear folder 17 and weaving J-shaped hooks 145-1 and 145-3 of middle folder 15-3 onto strap 242-2 of rear folder 17. The weaving of J-shaped hooks 145-1 through 145-4 onto their respective straps 242 can be done in an analogous fashion to that described above in connection with J-shaped hooks 45-1 through 45-4 of front folder 13 and straps 142-1 and 142-2 of middle folder 15-1. Method 310 concludes with a step 310-9 of inserting cover flap 123 of middle folder 15-3 into pocket 237 of rear folder 17.

Referring back now to FIGS. 4 and 5, the telescopic coupling of front folder 13 and middle folder 15-1 can be seen in greater detail, it being understood that similar connections are present between middle folder 15-1 and middle folder 15-2, between middle folder 15-2 and middle folder 15-3, and between middle folder 15-3 and rear folder 17. As can be seen, each hook 45 is slidably coupled to (also referred to as “mounted on”) its respective strap 142, with the range of motion between front folder 13 and middle folder 15-1 being delimited at one end by J-shaped hooks 45-1 and 45-2 reaching their uppermost position on straps 142-2 and 142-1, respectively, and being delimited at the opposite end by J-shaped hooks 45-3 and 45-4 reaching their lowermost position on straps 142-2 and 142-1, respectively. As seen best in FIG. 5, when folders 13 and 15-1 are fully expanded relative to one another, i.e., with J-shaped hooks 45-3 and 45-4 at their lowermost positions on straps 142-2 and 142-1, respectively, much of the weight of front folder 13 is supported by J-shaped hooks 45-2 and 45-4. To minimize the likelihood that through-cuts 44-2 and 44-4 may tear due to this weight and the stress imposed on through-cuts 44-2 and 44-4 by straps 142-2 and 142-1, respectively, terminal ends 62-2 and 66-2 of through-cuts 44-2 and 44-4, respectively, extend past straps 142-2 and 142-1 in the manner discussed above.

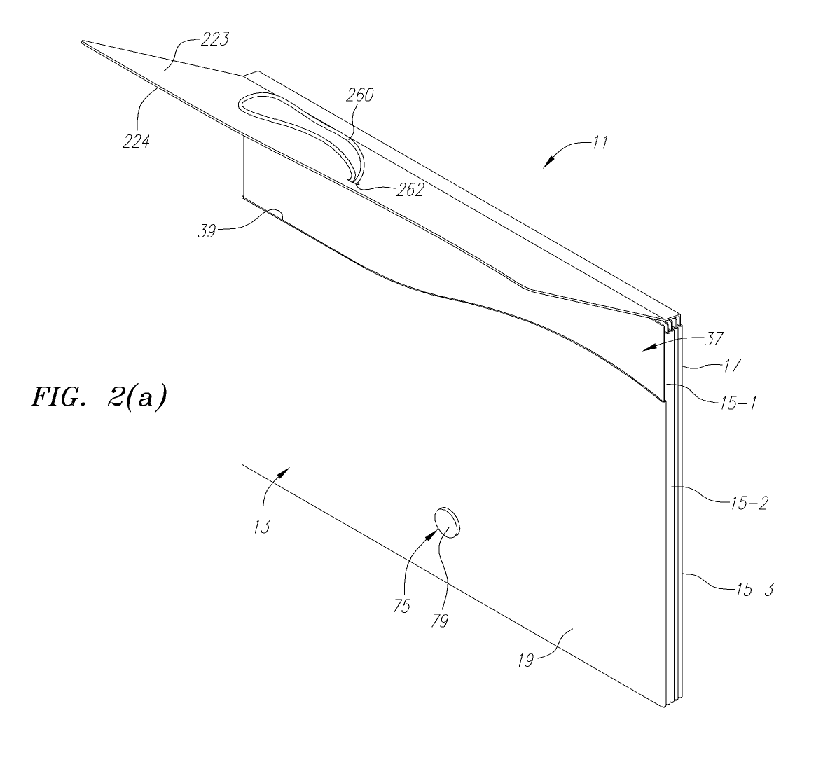

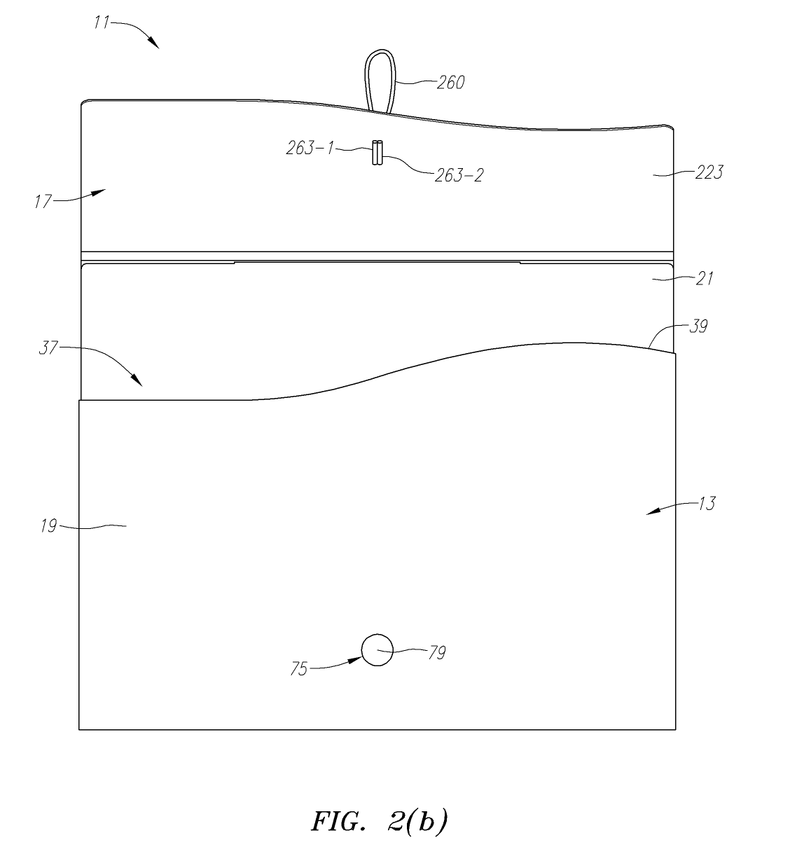

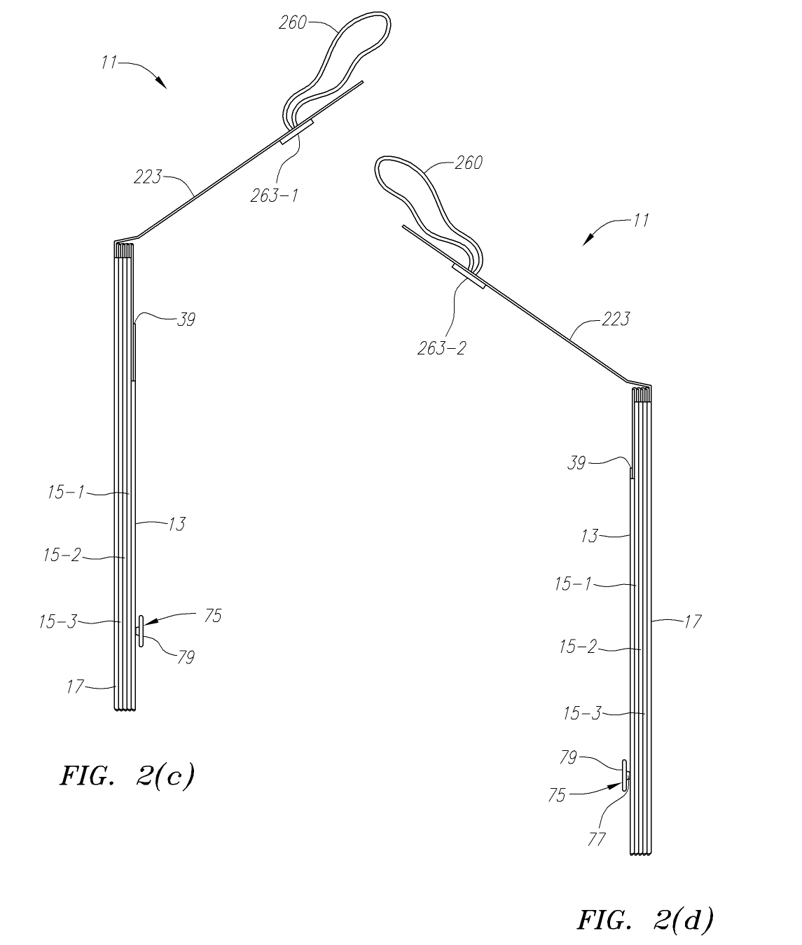

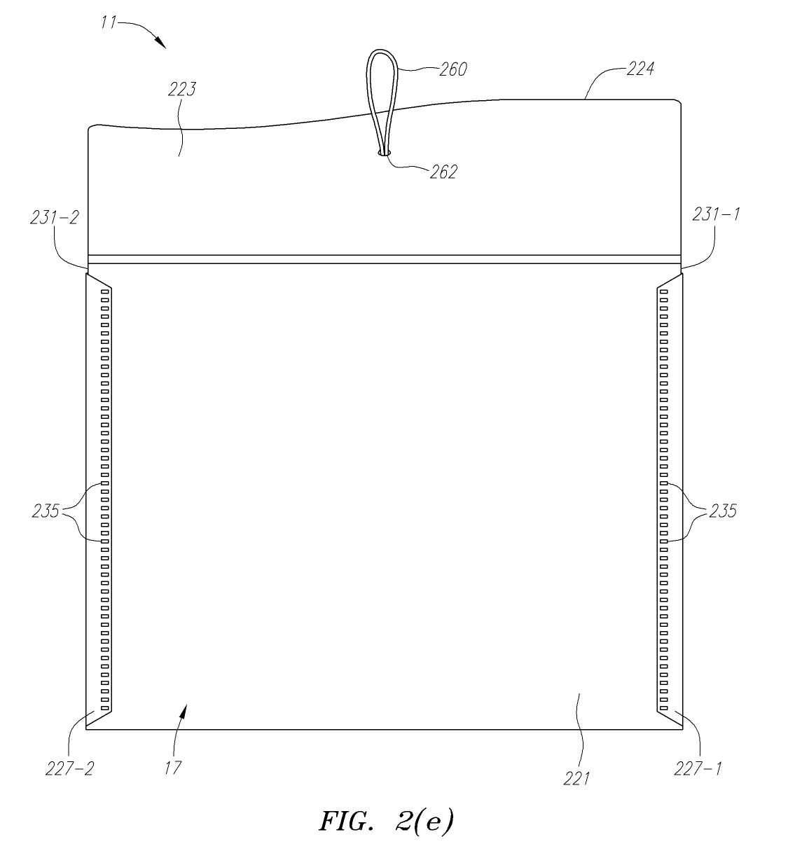

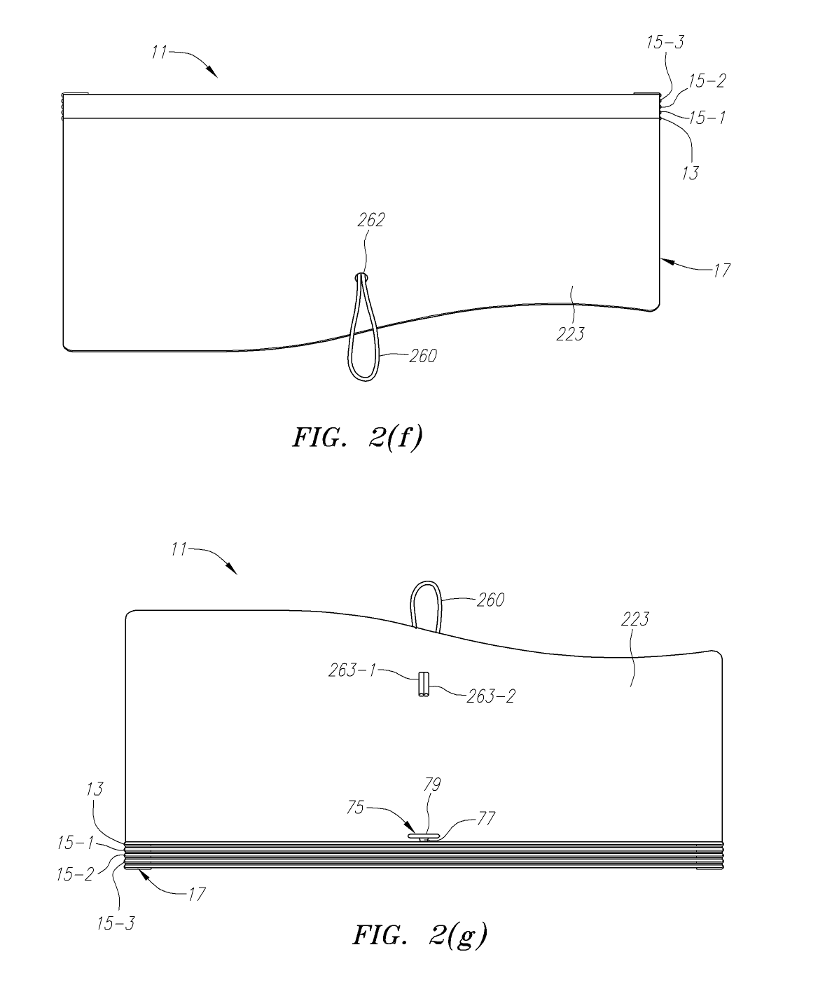

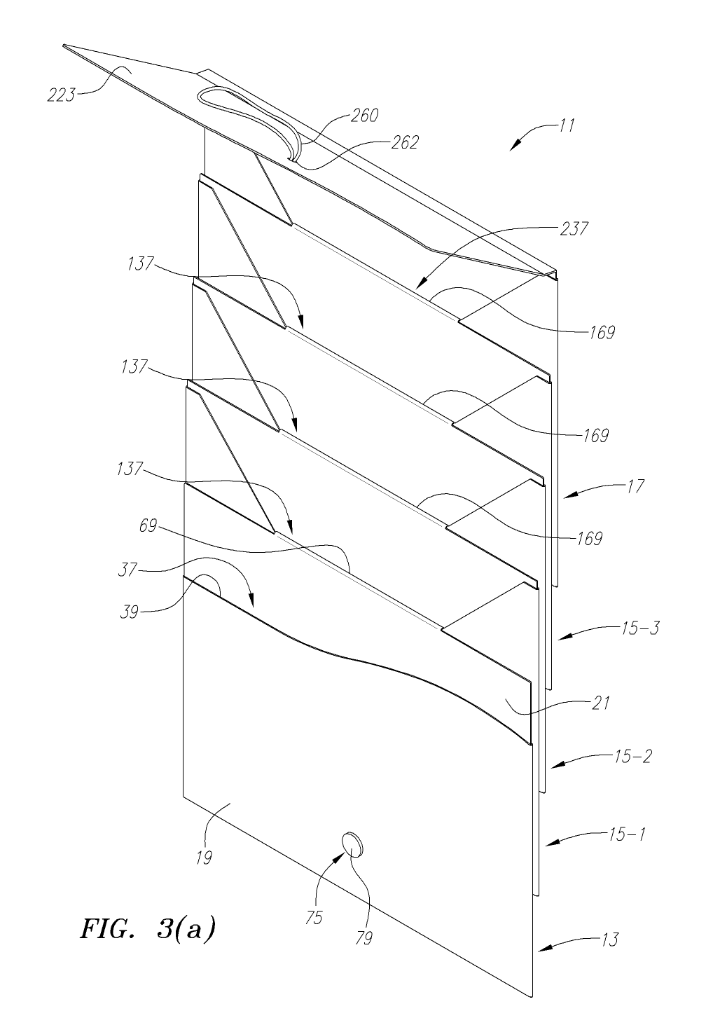

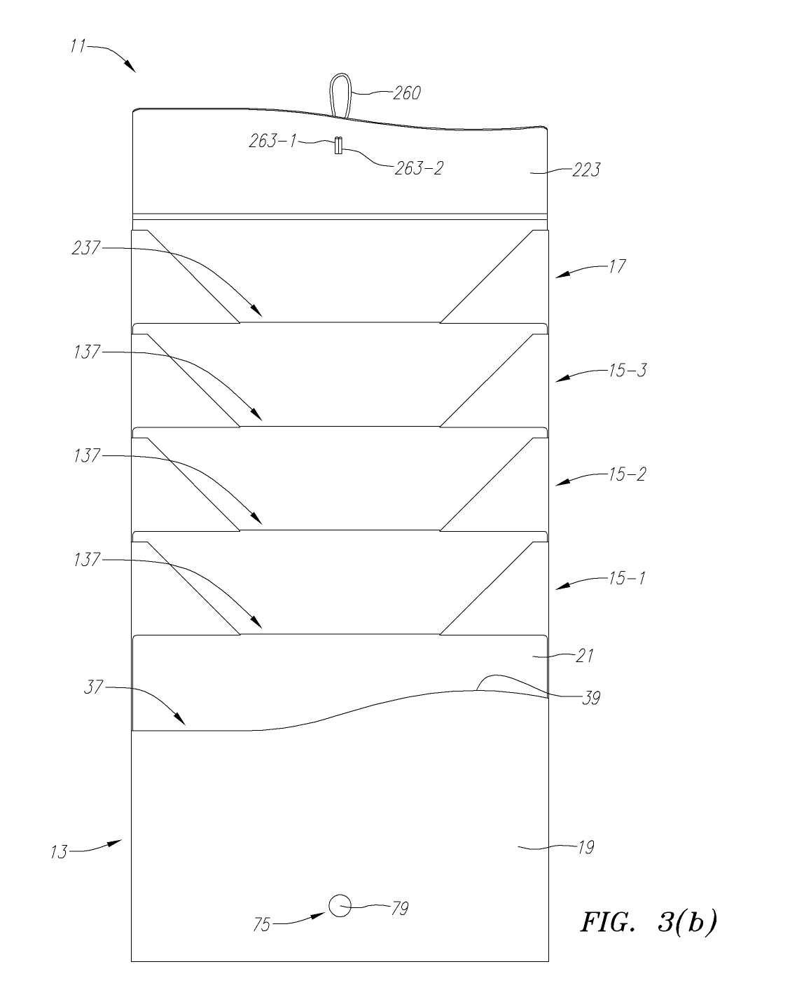

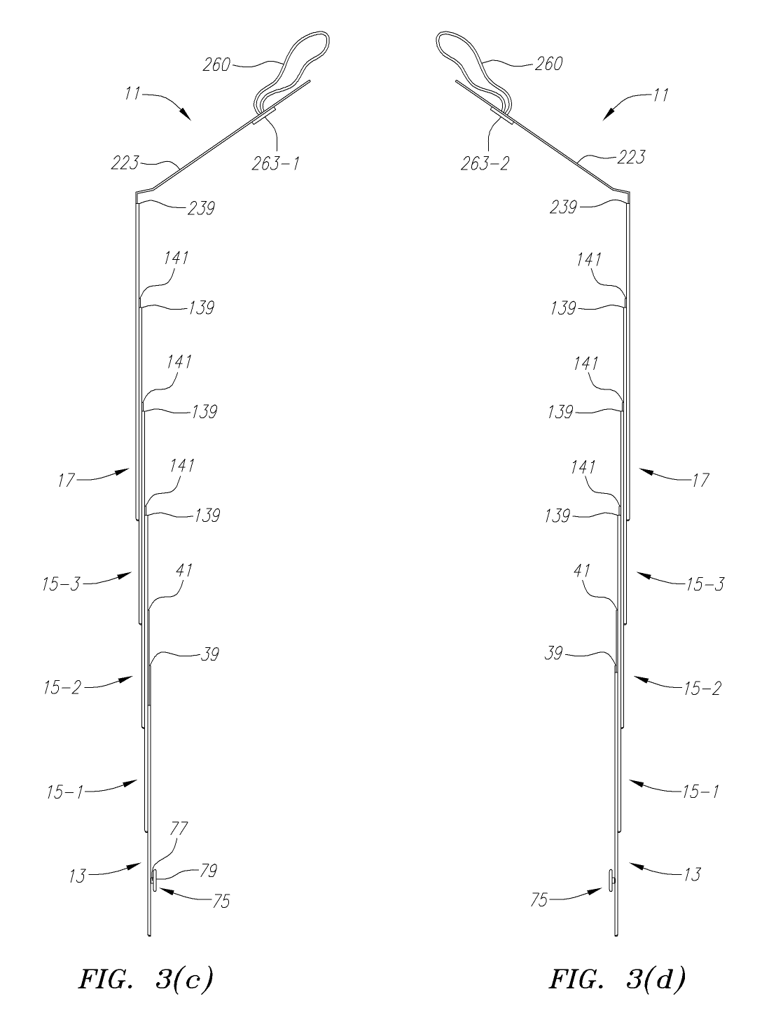

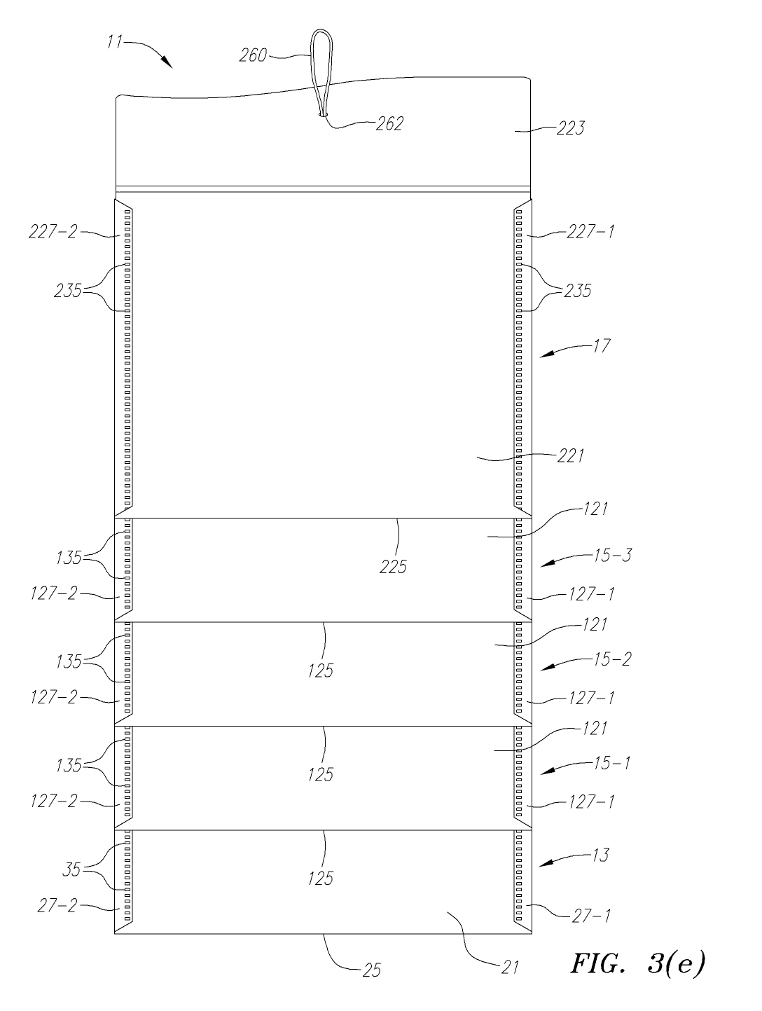

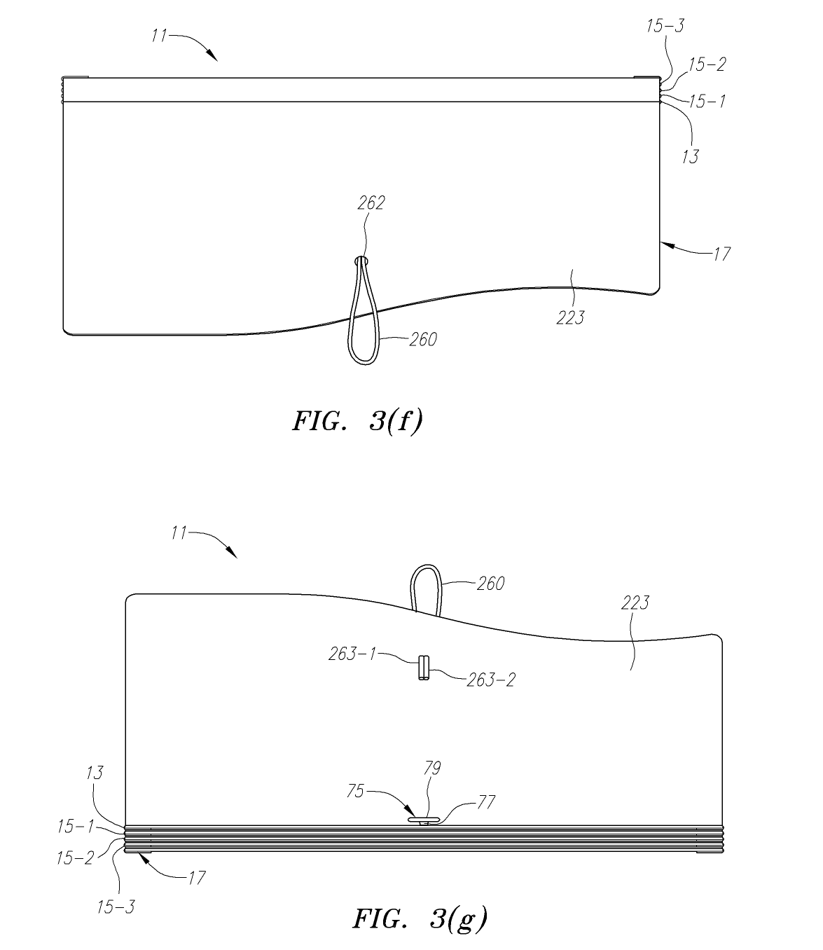

In use, with folder assembly 11 in a closed and compacted state, such as is shown in FIG. 1, one can decouple strap 260 from knob 75, thereby enabling cover flap 223 to be pivoted away from knob 75. Then, by orienting folder assembly 11 vertically and by holding folder assembly 11 via rear folder 17, each of the remaining folders of folder assembly 11 can be drawn down by gravity or by hand to telescope away from its adjacent folder(s), thereby causing folder assembly 11 to adopt an expanded configuration of the type shown, for example, in FIG. 3(a). It should be understood that, instead of orienting folder assembly 11 vertically, one could alternatively orient assembly in some other fashion, such as horizontally (e.g., on a desk or table), and manually telescope each of the folders away from its neighboring folder(s) to achieve an expanded configuration. In either case, with folder assembly 11 thus expanded, the contents of all of folders 13, 15-1, 15-2, 15-3, and 17 can be simultaneously viewed and, if desired, items can be inserted into or withdrawn from any one or more of folders 13, 15-1 through 15-3, and 17. It should also be understood that, instead of fully expanding folder assembly 11 as shown in FIG. 3(a), folder assembly 11 can alternatively be partially expanded so that only certain of the folders of folder assembly 11 are telescopically moved relative to its/their adjacent folder(s), with other folders of folder assembly 11 not being telescopically moved relative to its/their neighbors. Such a partial expansion can be effected, for example, by orienting folder assembly 11 vertically and holding some, but not all, of the folders stationary while allowing gravity or some other force to slide the remaining folder(s). Alternatively, such a partial expansion can also be effected by orienting folder assembly 11 horizontally, such as on a desk or table, and manually telescoping some, but not all, of the folders. Thereafter, to transform folder assembly 11 from an expanded state, such as is shown, for example, in FIG. 3(a), to a compacted state, such as is shown, for example, in FIG. 2(a), one can simply slide folders 13 and 17 towards one another until they are in registry, which will also cause middle folders 15-1 through 15-3 to be slid into registry with folders 13 and 17. This approach to compacting folder assembly 11 can also be taken where only some of the folders of folder assembly 11 are telescoped. To maintain folder assembly 11 in a compacted state, one can loop strap 260 around knob 75.

Owing in large part to its construction, some of the advantages of folder assembly 11 include the ease with which folder assembly 11 can be telescoped open and shut and the ease with which folder assembly 11 can be assembled, particularly the attachment of the J-shaped hooks of one folder with the straps of an adjacent folder.

All features disclosed in the specification, including the claims, abstract, and drawings, and all of the steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1. A folder assembly comprising:
a first folder, the first folder including a first hook; and
a second folder, the second folder including a first strap, and wherein the first hook of the first folder is slidably coupled to the first strap of the second folder, whereby the first folder and the second folder are telescopically coupled to one another.

2. The folder assembly according to claim 1, wherein:
the first folder further includes a second hook; and
the second hook of the first folder is slidably coupled to the first strap of the second folder.

3. The folder assembly according to claim 1, wherein:
the second folder further includes a second strap;
the first folder further includes a second hook; and
the second hook of the first folder is slidably coupled to the second strap of the second folder.

4. The folder assembly according to claim 1, wherein:
the first folder includes a front panel, a back panel, and a pocket;
the pocket is at least in part defined by the front panel and the back panel; and
the first hook is integrally formed in the back panel.

5. The folder assembly according to claim 1, wherein:
the second folder includes a front panel, a back panel and a pocket;
the pocket is at least in part defined by the front panel and the back panel; and
the first strap is integrally formed in the front panel.

6. The folder assembly according to claim 1, wherein:
the first folder includes a front panel, a back panel, and a pocket;
the pocket of the first folder is at least in part defined by the front panel and the back panel of the first folder;
the first hook is integrally formed in the back panel of the first folder;
the second folder includes a front panel, a back panel, and a pocket;
the pocket of the second folder is at least in part defined by the front panel and the back panel of the second folder; and
the first strap is integrally formed in the front panel of the second folder.

7. The folder assembly according to claim 6, wherein the first folder further includes a cover flap, the cover flap of the first folder inserted into the pocket of the second folder.

8. The folder assembly according to claim 1, wherein:
the first folder is generally rectangular and includes an open top, a bottom, and a pair of sides;
the second folder is generally rectangular and includes an open top, a bottom, and a pair of sides;
the first strap is oriented generally parallel to the sides of the second folder; and
the first hook is oriented at a downward angle relative to an imaginary line perpendicular to the sides of the first folder.

9. The folder assembly according to claim 8, wherein the first hook is defined by a through-cut in the first folder, the through-cut having a first terminal end and a second terminal end and defining a long leg, a short leg, and a transverse leg, the long leg fixed to the first folder, the short leg not fixed to the first folder, the transverse leg interconnecting the long leg and the short leg.

10. The folder assembly according to claim 9, wherein the first terminal end and the second terminal end are spaced different distances from the sides of the first folder.

11. The folder assembly according to claim 1, wherein at least one of the first folder and the second folder further includes a closure mechanism for maintaining the first and second folders in registry with one another.

12. The folder assembly according to claim 11, wherein the closure mechanism includes a knob on one of the first and second folders and an elastic loop on the other of the first and second folders.

13. The folder assembly according to claim 1, wherein:
the second folder further includes a first hook;
the folder assembly further includes a third folder;
the third folder including a first strap;
the first hook of the second folder is slidably coupled to the first strap of the third folder; and
the second folder and the third folder are telescopically coupled to one another.

14. The folder assembly according to claim 13, wherein:
the third folder further includes a first hook;
the folder assembly further includes a fourth folder;
the fourth folder including a first strap;
the first hook of the third folder is slidably coupled to the first strap of the fourth folder; and
the third folder and the fourth folder are telescopically coupled to one another.

15. The folder assembly according to claim 14, wherein:
the fourth folder further includes a first hook;
the folder assembly further includes a fifth folder;
the fifth folder including a first strap;
the first hook of the fourth folder is slidably coupled to the first strap of the fifth folder; and
the fourth folder and the fifth folder are telescopically coupled to one another.

16. The folder assembly according to claim 15, wherein the second, third, and fourth folders are identical.

17. A folder assembly comprising:
a first folder, the first folder including a front panel and a back panel, the front panel and the back panel interconnected at their respective bottoms by a fold line and joined to each other at their respective sides, whereby the front panel and the back panel jointly define a pocket having an open top, the back panel configured to define a plurality of flexible hooks; and
a second folder, the second folder including a front panel and a back panel, the front panel and the back panel interconnected at their respective bottoms by a fold line and joined to each other at their respective sides, whereby the front panel and the back panel jointly define a pocket having an open top, the front panel configured to define a plurality of flexible straps; wherein
the flexible hooks of the first folder are slidably coupled to the flexible straps of the second folder, and
the first folder and the second folder are telescopically coupled to one another.

18. The folder assembly according to claim 17, wherein:
the flexible hooks on the back panel of the first folder are arranged in two groups;
one of the two groups of flexible hooks is slidably coupled to a first flexible strap; and
the other of the two groups of flexible hooks is slidably coupled to a second flexible strap.

19. The folder assembly according to claim 18, wherein the first and second flexible straps generally are parallel to one another and generally are parallel to the sides of the second folder.

20. The folder assembly according to claim 19, wherein the first and second flexible straps are defined by through-cuts in the front panel of the second folder.

21. The folder assembly according to claim 20, wherein:
the first flexible strap is defined by a first pair of through-cuts in the front panel of the second folder; and
the second flexible strap is defined by a second pair of through-cuts in the front panel of the second folder.

22. The folder assembly according to claim 19, wherein the flexible hooks are angled downwardly relative to an imaginary line perpendicular to the sides of the back panel of the first folder.

23. The folder assembly according to claim 22, wherein each of the flexible hooks is defined by a single through-cut in the back panel of the first folder.

24. The folder assembly according to claim 23, wherein each of the two groups of flexible hooks includes at least two flexible hooks.

25. The folder assembly according to claim 24, wherein:
each of the at least two flexible hooks includes a long leg, a short leg, and a transverse leg;
the long leg fixed to the first folder proximate to a first side;
the short leg not fixed to the first folder; and
the transverse leg interconnecting the long leg and the short leg.

26. The folder assembly according to claim 25, wherein:
each of the at least two flexible hooks includes a bottom hook;
each of the through-cuts includes an upper terminal end and a lower terminal end; and
the lower terminal end of the through-cut for the bottom hook closer to the first side than is the upper terminal end of the through-cut for the bottom hook and the upper and lower terminal ends of the remaining hooks of the at least two flexible hooks.

27. The folder assembly according to claim 17, wherein:
the first folder further includes a cover flap;
the cover flap connected to the back panel by a fold line; and
the cover flap inserted into the pocket of the second folder.

28. The folder assembly according to claim 17, wherein at least one of the first folder and the second folder further includes a closure mechanism for maintaining the first and second folders in registry with one another.

29. The folder assembly according to claim 28, wherein:
the second folder further includes a cover flap;
the cover flap connected to the back panel by a fold line; and
the closure mechanism includes a knob on the front panel of the first folder and an elastic loop on the cover flap of the second folder.

30. The folder assembly according to claim 17, wherein:
the back panel of the second folder is configured to define a plurality of flexible hooks;
the folder assembly further includes a third folder;
the third folder including a front panel and a back panel;
the front panel and the back panel interconnected at their respective bottoms by a fold line and joined to each other at their respective sides;
the front panel and the back panel jointly define a pocket having an open top;
the front panel configured to define a plurality of flexible straps;
the flexible hooks of the second folder are slidably coupled to the flexible straps of the third folder;
the second folder and the third folder are telescopically coupled to one another.

31. A method of assembling a plurality of folders, the method comprising the steps of:
(a) providing a first folder, the first folder including a first hook;
(b) providing a second folder, the second folder including a first strap; and
(c) slidably coupling the first hook of the first folder on the first strap of the second folder so as to telescopically couple the first folder and the second folder to one another.

32. The method according to claim 31, wherein the slidably coupling step includes hooking the first hook around a side edge of the first strap.

33. The method according to claim 31, wherein:
the first folder has a cover flap;
the second folder has a pocket; and
the method further including the step of inserting the cover flap of the first folder into the pocket of the second folder.

34. The method according to claim 31, wherein:
the second folder includes a first hook; and
the method further including the steps of:
providing a third folder, the third folder including a first strap, and
slidably coupling the first hook of the second folder on the first strap of the third folder so as to telescopically couple the second folder and the third folder to one another.

35. The method according to claim 31, wherein the first hook is formed by a through-cut in a back panel of the first folder.

36. The method according to claim 35, wherein the first strap is formed by a through-cut in a front panel of the second folder.

37. The method according to claim 31, wherein the first strap is formed by a through-cut in a front panel of the second folder.

38. The method according to claim 31, wherein:
the first folder is generally rectangular and includes an open top, a bottom, and a pair of sides;
the second folder is generally rectangular and includes an open top, a bottom, and a pair of sides;
the first strap is oriented generally parallel to the sides of the second folder; and
the first hook is oriented at a downward angle relative to an imaginary line perpendicular to the sides of the first folder.

39. The method according to claim 31, wherein the first folder providing step includes the steps of:
(i) providing a sheet of material;
(ii) cutting and scoring the sheet of material to form a first folder blank including a first panel, a second panel joined to the first panel by a first fold line, and a third panel joined to the second panel by a second fold line, the first panel including a pair of side flaps, the second panel including a through-cut defining the first hook;
(iii) folding the first folder blank about the first fold line to bring together a rear surface of the first panel and a front surface of the second panel;
(iv) joining the side flaps to a rear surface of the second panel, whereby the first panel and the second panel jointly define a pocket having an open top; and
(v) folding the first folder blank about the second fold line to form a cover flap.

40. The method according to claim 39, wherein the second folder providing step includes the steps of:
(i) providing a sheet of material;
(ii) cutting and scoring the sheet of material to form a second folder blank including a first panel, a second panel joined to the first panel by a first fold line, and a third panel joined to the second panel by at least one second fold line, the first panel including a pair of side flaps and a through-cut defining the first strap;
(iii) folding the second folder blank about the first fold line to bring together a rear surface of the first panel and a front surface of the second panel;
(iv) joining the side flaps to a rear surface of the second panel, whereby the first panel and the second panel jointly define a pocket having an open top; and
(v) folding the blank about the at least one second fold line to form a cover flap.

41. The method according to claim 39, wherein the step of joining the side flaps to the rear surface of the second panel includes welding the side flaps to the rear surface of the second panel.

42. The method according to claim 39, wherein the step of joining the side flaps to the rear surface of the second panel includes gluing the side flaps to the rear surface of the second panel.

43. The method according to claim 40, wherein the step of joining the side flaps to the rear surface of the second panel includes welding the side flaps to the rear surface of the second panel.

44. The method according to claim 40, wherein the step of joining the side flaps to the rear surface of the second panel includes gluing the side flaps to the rear surface of the second panel.
